(19) United States
(12) Patent Application Publication
(10) Pub. No.: US 2007/0106515 A1
(43) Pub. Date: May 10, 2007

(54) Automated interactive statistical call visualization using abstractions stack model framework

(75) Inventor: Ngai Chiu Wong, San Ramon, CA (US)

Correspondence Address: GREENBLUM & BERNSTEIN, P.L.C., 1950 ROLAND CLARKE PLACE, RESTON, VA, 20191, US

(73) Assignee: SBC Knowledge Ventures, L.P., Reno, NV (US)

(21) Appl. No.: 11/269,634

(22) Filed: Nov. 9, 2005

(51) Int. Cl. G10L 21/00

(52) U.S. Cl. 704/270

(57) ABSTRACT

Statistical speech recognition application call data is visually presented. A data model is built using speech application data from disparate events. The data model is modified using predetermined abstraction rules. The modified data model is translated into a visual representation of the modified data model with multiple levels of abstraction. The visual representation of the data model is graphically displayed via an interactive graphical user interface that accepts user requests. A graphical display of the visual representation of the data model is transformed in response to receiving a user request via the interactive graphical user interface. The graphical display of a first speech data aggregate at a first level of abstraction and a second speech data aggregate at a second level of abstraction are changed as a result of the transformation.

### BACKGROUND OF THE INVENTION

1. Field of the Invention

The present disclosure relates to data presentation for speech recognition applications. More particularly, the present disclosure relates to automated interactive statistical call visualization using an abstractions stack model framework for presenting speech recognition application data.

2. Background Information

In recent years, speech application development for the automatic speech recognition industry has followed a defined lifecycle and methodology. Dialog designers rely on spreadsheets and/or other text editing tools to develop detailed dialog designs. Before an actual detailed dialog design is created, the dialog designers develop sample dialogs, and supplement them with visually drawn diagrams to illustrate high level call flows. Recently, commercial speech development integrated development environment (IDE) tools have been developed which automatically create flow diagrams for dialog design. However, such flow diagrams are still only used during the development process.

Visualization is effective in conveying speech application flow design and usability information. However, post-impact analysis typically comes in the form of one-dimensional tabulated statistics/reports or manually intensive call recording/user surveys. FIGS. 1-7 show tabulated statistics and reports resulting from post-impact analysis.

The table in FIG. 1 shows tabulations of call volume and disposition of calls received by an interactive voice response (IVR) system. As can be seen, a portion of the total calls (719) received by the IVR system are transferred, and a portion of the total calls are ended in the IVR system. The table in FIG. 2 shows the requests the 719 callers in FIG. 1 made at the main menu. 498 selections were made for family and medical leave act (FMLA) information, 108 selections were made for an agent, and 163 selections were made for an “other” option for processing or ending the call. The differences in totals between FIG. 2 and FIG. 1 may result from a caller being allowed to select more than one option, e.g., by being allowed to return to a “main menu” during a call flow. Throughout the drawings, the “totals” may not appear to be consistent due to options and actions that are not detailed.

FIG. 3 shows FMLA menu requests. FIG. 4 shows agent requests and the results of 34 callers who selected a human resources service center (HRSC) and who are asked to pick a topic from a list of choices. For example, 12.5% of callers select an electronic personnel change request (EPCR) in FIG. 4. FIG. 5 shows the tabulated results of corporate information security (CIS) interaction categorized as either “failed” or “succeeded”. The table in FIG. 6 shows total call transfers from the IVR.

An actual report or the original versions of the examples above may have many more tables and rows of statistics than shown. As a result, a designer may need to walk through the statistics in detail with clients, since they are not immediately obvious and can leave room for misinterpretation.

A visual representation of statistics, directly incorporated into a flow diagram, immediately delivers comprehension and removes room for misinterpretation. An exemplary visual representation of statistics directly incorporated into a flow diagram, is shown in FIG. 7. The example shown in FIG. 7 would be hand-drawn, and therefore requires an intensive manual effort to produce. FIG. 7 is an attempt to resolve the limitations associated with presenting tabulated data.

An important audience of post-impact analysis is dialog designers who analyze details of call flow and usability. Dialog designers review tabulated statistics of grammar accuracy reports (typically with transcription results) and user requests in each dialog state. Even though the tabulated statistics help in the analysis of effectiveness and coverage for each particular grammar or dialog state, it does not indicate where users came from or where they are going, and how the particular dialog state affected the overall experience.

For analysis using tabulated statistics, the audience would benefit from a flow diagram that explains how the numbers relate to the application design/flow. However, dialog designers have resorted to using user surveys and entire call recordings to gauge usability and flow efficiency to compensate for the limitations of tabulated statistics. A recommended 100 calls are recorded in order to conduct a statistically significant call recording study. Experienced dialog designers then listen to the calls, categorize them, and make detailed notes on the users' experiences. The dialog designer weighs users with contrasting experiences, and makes initial recommendations on improvement based on the result. The initial recommendations will be given to a data analyst who runs tabulated statistics on associated dialogs to see if users would benefit from the proposed changes. The validation with tabulated statistics is necessary because 100 calls is a small sample for an application which may have numerous transfer destinations and self service modules. From a 100 sample analysis, as few as 2 or 3 calls may travel down the same general path of requests, and even then these calls may divert into separate branches. As a result, initial recommendations are often made based on the experiences of as few as two users. As one can imagine, the above-described analysis is time-consuming and requires experienced dialog designers who usually need to be contracted from professional services companies. The matter is worse if the tuning target is a new application with a small caller population.

Numerous calls are recorded before it is possible to capture the calls for this analysis. User surveys are just as labor intensive as call recording analysis, and are subject to even more limiting constraints. User surveys are typically used for scoring an application. However, user surveys may also be employed to expose problematic user experience areas. Often difficult to compile, labor intensive, and lacking the required specifics for tuning recommendations, user surveys lack statistical significance unless hundreds of surveys are completed.

The tabulations and hand-drawn flow diagram described above demonstrate the need for an automated statistical call visualization tool.

### BRIEF DESCRIPTION OF THE DRAWINGS

The present invention is further described in the detailed description that follows, by reference to the noted drawings by way of non-limiting examples of embodiments of the present disclosure, in which like reference numerals represent similar parts throughout several views of the drawing, and in which:

FIG. 1 shows an example of a conventional report of tabulated call-flow statistics;

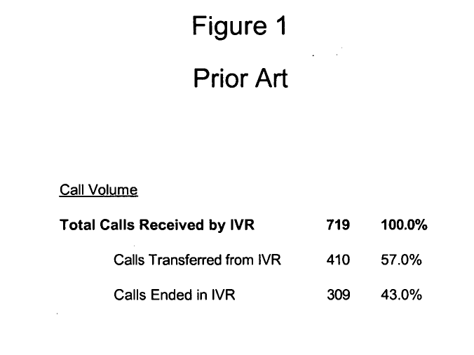

FIG. 2 shows another example of a conventional report of tabulated call-flow statistics;

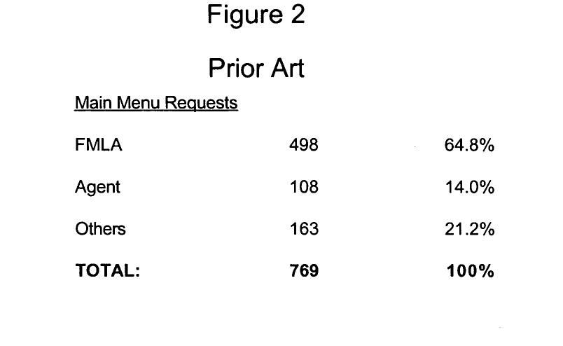

FIG. 3 shows another example of a conventional report of tabulated call-flow statistics;

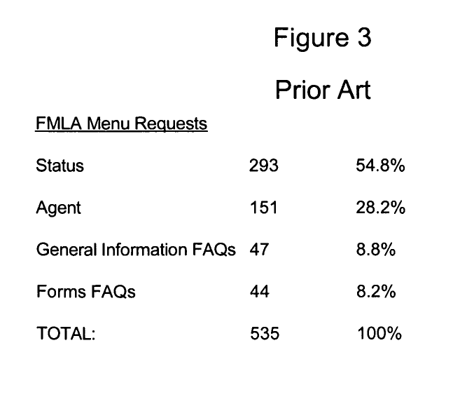

FIG. 4 shows another example of a conventional report of tabulated call-flow statistics;

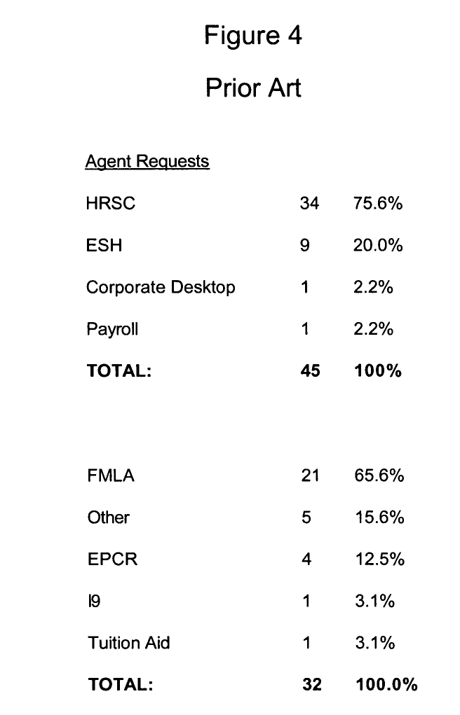

FIG. 5 shows another example of a conventional report of tabulated call-flow statistics;

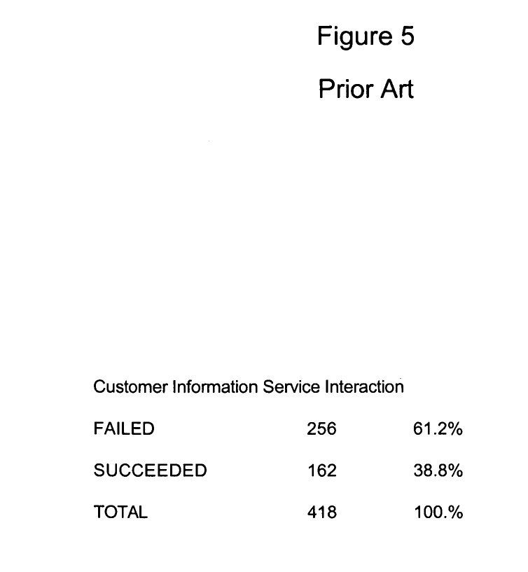

FIG. 6 shows another example of a conventional report of tabulated call-flow statistics;

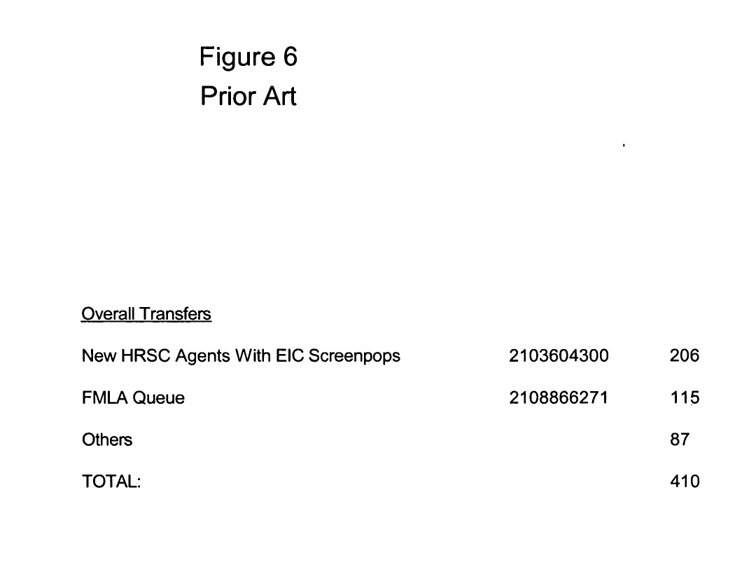

FIG. 7 shows an exemplary visual representation of conventional call-flow statistics incorporated by hand into a flow diagram;

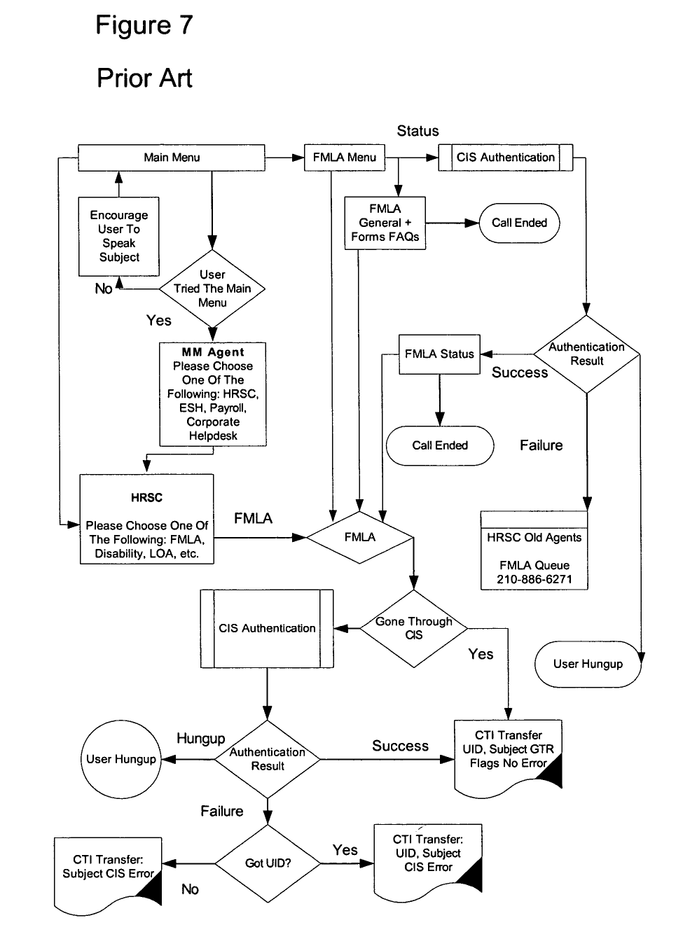

FIG. 8 shows an exemplary general computer system that includes a set of instructions for performing a method of automated interactive statistical call visualization using abstractions stack model framework;

FIG. 9 shows an exemplary representation of models and visual facet arrays for phases of automated interactive statistical call visualization using abstractions stack model framework;

FIG. 10 shows an exemplary user-centric structured flow-aware diagram at a dialog state abstraction according to an aspect of automated interactive statistical call visualization using abstractions stack model framework;

FIG. 11 shows an exemplary user-centric structured flow-aware diagram at a sub-dialog state abstraction according to an aspect of automated interactive statistical call visualization using abstractions stack model framework;

FIG. 12 shows an exemplary empty-arrows diagram according to an aspect of automated interactive statistical call visualization using abstractions stack model framework;

FIG. 13 shows an exemplary Venn diagram according to an aspect of automated interactive statistical call visualization using abstractions stack model framework;

FIG. 14 shows an exemplary user-centric unstructured flow-aware diagram according to an aspect of automated interactive statistical call visualization using abstractions stack model framework;

FIG. 15 shows an exemplary neutral multi-to-multi unstructured flow-unaware diagram according to an aspect of automated interactive statistical call visualization using abstractions stack model framework;

FIG. 16 shows an exemplary Venn diagram according to an aspect of automated interactive statistical call visualization using abstractions stack model framework;

FIG. 17 shows an exemplary bar chart according to an aspect of automated interactive statistical call visualization using abstractions stack model framework;

FIG. 18 shows an exemplary chart according to an aspect of automated interactive statistical call visualization using abstractions stack model framework;

FIG. 19 shows an exemplary method of breaking down a dialog state abstraction to a sub-dialog state abstraction according to an aspect of automated interactive statistical call visualization using abstractions stack model framework;

FIG. 20 shows an exemplary method of building up a dialog state abstraction to a dialog state abstraction according to an aspect of automated interactive statistical call visualization using abstractions stack model framework;

FIG. 21 shows an exemplary naming process according to an aspect of automated interactive statistical call visualization using abstractions stack model framework;

FIG. 22 shows an exemplary recursive naming loop according to an aspect of automated interactive statistical call visualization using abstractions stack model framework;

FIG. 23 shows an exemplary diagram according to an aspect of automated interactive statistical call visualization using abstractions stack model framework;

FIG. 24 shows exemplary calls at a call interaction abstraction according to an aspect of automated interactive statistical call visualization using abstractions stack model framework;

FIG. 25 shows an exemplary flow aware dialog state namer according to an aspect of automated interactive statistical call visualization using abstractions stack model framework;

FIG. 26 shows an exemplary flow unaware dialog state namer according to an aspect of automated interactive statistical call visualization using abstractions stack model framework;

FIG. 27 shows an exemplary diagram of a main menu dialog state broken down to a sub dialog state abstraction according to an aspect of automated interactive statistical call visualization using abstractions stack model framework;

FIG. 28 shows an exemplary method for performing automated interactive statistical call visualization using abstractions stack model framework;

FIG. 29 shows an exemplary screen-shot visualization of a load phase of software usage;

FIG. 30 shows an exemplary screen-shot visualization of a build phase of software usage;

FIG. 31 shows an exemplary screen-shot visualization of a navigate phase of software usage;

FIG. 32 shows an exemplary screen-shot visualization of a transform phase of software usage;

FIG. 33 shows an exemplary table correlating high-level aggregate speech data with lower level aggregate speech data for a call;

FIG. 34 shows an exemplary table correlating main menu prompt call interactions at different points in the same call; and

FIG. 35 shows an exemplary screen-shot illustrating a sub dialog state abstraction that gauges the effectiveness of a selected type of aggregate speech data.

### DETAILED DESCRIPTION

In view of the foregoing, the present disclosure, through one or more of its various aspects, embodiments and/or specific features or sub-components, is thus intended to bring out one or more of the advantages as specifically noted below.

As described below, automated interactive statistical call visualization is used to present actual usage patterns and statistics as diagram formats. A data model is built, modified and translated into a visual representation with multiple levels of abstraction. A visual display of the visual representation of the data model can be transformed by the user to display different levels of abstraction simultaneously for different nodes.

The framework for building, modifying and translating the data model is based on abstraction stacks. Abstraction stacks are data structures such as a set of rules. A stack has multiple namers. One or more rules called a “namer” is used to name aggregated speech data in a predetermined state (level). An individually identifiable collection of aggregated speech data (a “speech data aggregate”) is herein referred to as a concept. Individually identifiable collections of speech data may exist for speech application activities such as prompts, events, inputs and outcomes. A stack thus defines one or more abstraction states (levels) of a concept by naming the concepts. As a result, each concept has a reference to a stack. The stack can name a concept at any level of abstraction possible for the concept.

The stacks and the namers can be dynamically updated in real-time. Stacks have heuristics implications so that new rules (namers) can be created and applied. The stacks are designed so that operations are reversible, eliminating a need for “undo” transformations.

Abstraction states are categories of concepts as defined by parameters, characteristics, attributes and data. For example, the first (lowest) abstraction state of concepts may include individual i. system prompts, ii. system events, iii. user input and iv. event outcomes. The concept for each individual prompt, event, input or outcome is a set of data that includes associated and descriptive parameters, characteristics and attributes.

As an example, a concept at a higher abstraction state might represent a subgroup of the lowest abstraction state concepts. Therefore, a second abstraction state might define a concept that represents a group of only core interaction events (e.g., system prompts and user input) together. A third abstraction state higher than the second abstraction state might than define the core interaction events into groups of events. For example, a concept at the third abstraction state might represent (e.g., a summary, an average or a range of data for) lower-level concepts of events that occur less than 1 minute from the beginning of a call and lower-level concepts of events that occur more than 1 minute from the beginning of a call.

As described herein, “concepts” are a generic atomic unit used to build any visualization models. Concept grouping is reduced to namespace management, where identically named concepts belong to the same group. Designers therefore are able to focus on expressing differences in grouping through names, and leave the actual grouping, deleting, updating, statistics aggregation, etc. to the model framework.

The grouping algorithm is implemented piecewise, one abstraction namer at a time. As part of the design process, concepts are automatically assigned a meaningful name, which simplifies statistics calculation, transformation to templates, go-back and other features.

Once stacks are decided, all inter-namer transformations are available. Each stack is composed of abstraction namers, each of which has an algorithm to determine the name of a higher level concept (called a “super concept”) for any unassigned concept. Thus, for each abstraction level, the appropriate namer will examine each concept for assignment of a name as a sub-concept to a concept of the (target) abstraction level. Names are assigned using the parameters, characteristics, attributes and data of each concept.

The framework provides high scalability optimization and a statistics reporting architecture.

According to an aspect of the present disclosure, a method for visually presenting statistical speech recognition application call data is provided. A data model is built using speech application data from disparate events. The data model is modified using predetermined abstraction rules. The modified data model is translated into a visual representation of the modified data model with multiple levels of abstraction. The visual representation of the data model is graphically displayed to a user via an interactive graphical user interface that accepts user requests. A graphical display of the visual representation of the data model is transformed, in response to receiving a user request via the interactive graphical user interface, to change the graphical display of at least one first speech data aggregate at a first level of abstraction and the graphical display of at least one second speech data aggregate at a second level of abstraction.

According to another aspect of the present disclosure, the transforming further includes at least one of expanding, eliminating and grouping speech data aggregates. The speech application data includes statistics corresponding to at least one event recognized by a speech recognition application.

According to still another aspect of the present disclosure, call data is assigned different names at different abstraction levels. Each name is calculated based upon at least one characteristic of an associated speech data aggregate and a relationship with at least one other speech data aggregate. Disparate call data having a name in common is grouped to create a data structure that can be managed according to name components.

According to yet another aspect of the present disclosure, the predetermined abstraction rules include multiple rules for naming speech data aggregates at multiple levels of abstraction. Each of the multiple rules is associated with a level of abstraction defined by the user. Each rule is used to examine call data characteristics. The examination result contributes to the determination of an intermediate name and/or is used to determine a final name for each speech data aggregate.

According to another aspect of the present disclosure, a stack of predetermined abstraction rules defines a set of allowable transformations for at least one speech data aggregate. The stack of predetermined abstraction rules is customizable by the user so that speech data aggregates can be associated with different rules for display at different abstraction levels according to input of the user.

According to still another aspect of the present disclosure, new stacks are dynamically created from existing stacks, by at least one of inserting, deleting and changing an order of abstraction namers. Affected speech data aggregates are associated with a new stack when the user modifies the set of allowable transformations at run-time.

According to yet another aspect of the present disclosure, the transformations include initially reducing the data structure to a set of speech data aggregates at an elemental level of abstraction. All transformations also include combining data of speech data aggregates at the elemental level of abstraction to build at least one speech data aggregate at a higher level of abstraction, so that the visual representation of the data model includes only an elemental level of abstraction and a topmost level of abstraction.

According to an aspect of the present disclosure, a computer readable medium is provided for storing a computer program that visually presents statistical speech recognition application call data. A model building code segment builds a data model using speech application data from disparate events. A model modifying code segment modifies the data model using predetermined abstraction rules. A model translating code segment translates the modified data model into a visual representation of the data model with multiple levels of abstraction. A model presenting code segment graphically displays the visual representation of the data model via an interactive graphical user interface that accepts user requests. A display transforming code segment transforms a graphical display of the visual representation of the data model, in response to receiving a user request via the interactive graphical user interface, to change the graphical display of at least one first speech data aggregate at a first level of abstraction and the graphical display of at least one second speech data aggregate at a second level of abstraction.

According to another aspect of the present disclosure, the display transforming code segment at least one of expands, eliminates and groups speech data aggregates. The speech application data includes statistics corresponding to at least one event recognized by a speech recognition application.

According to still another aspect of the present disclosure, a naming code segment assigns call data different names at different abstraction levels. Each name is calculated based upon at least one characteristic of an associated speech data aggregate and a relationship to at least one other speech data aggregate. Disparate call data having a name in common is grouped to create a data structure that can be managed according to name components.

According to yet another aspect of the present disclosure, the predetermined abstraction rules include multiple rules for naming speech data aggregates at multiple levels of abstraction. Each of the multiple rules is associated with a level of abstraction defined by the user. Each rule is used to examine call data characteristics. The examination result contributes to the determination of an intermediate name and/or is used to determine a final name for each speech data aggregate.

According to another aspect of the present disclosure, a stack of predetermined abstraction rules defines a set of allowable transformations for at least one speech data aggregate. The stack of predetermined abstraction rules is customizable by the user so that speech data aggregates can be associated with different rules for display at different abstraction levels according to input of the user.

According to still another aspect of the present disclosure, a new stack code segment dynamically creates new stacks from existing stacks, by at least one of inserting, deleting and changing an order of abstraction namers. Affected speech data aggregates are associated with a new stack when the user modifies the set of allowable transformations at run-time.

According to yet another aspect of the present disclosure, the transformations include initially reducing the data structure to a set of speech data aggregates at an elemental level of abstraction. All transformations also include combining data of speech data aggregates at the elemental level of abstraction to build at least one speech data aggregate at a higher level of abstraction, so that the visual representation of the data model includes only an elemental level of abstraction and a topmost level of abstraction.

According to an aspect of the present disclosure, a visual statistical speech recognition application call data presenter is provided. A builder builds a data model using speech application data from disparate events. A modifier modifies the data model using predetermined abstraction rules. A translator translates the modified data model into a visual representation of the modified data model with multiple levels of abstraction. A model displayer graphically displays the visual representation of the data model via an interactive graphical user interface that accepts user requests. A transformer transforms a graphical display of the visual representation of the data model, in response to receiving a user request via the interactive graphical user interface, to change the graphical display of at least one first speech data aggregate at a first level of abstraction and the graphical display of at least one second speech data aggregate at a second level of abstraction.

According to another aspect of the present disclosure, the model transformer at least one of expands, eliminates and groups speech data aggregates. The speech application data includes statistics corresponding to at least one event recognized by a speech recognition application.

According to still another aspect of the present disclosure, a namer assigns call data different names at different abstraction levels. Each name is calculated based upon at least one characteristic of an associated speech data aggregate and a relationship to at least one other speech data aggregate. Disparate call data having a name in common is grouped to create a data structure that can be managed according to name components.

According to yet another aspect of the present disclosure, the predetermined abstraction rules include multiple rules for naming speech data aggregates multiple levels of abstraction. Each of the multiple rules is associated with a level of abstraction defined by the user. Each rule is used to examine call data characteristics. The examination result contributes to the determination of an intermediate name and/or is used to determine a final name for each speech data aggregate.

According to another aspect of the present disclosure, a stack of predetermined abstraction rules defines a set of allowable transformations for at least one speech data aggregate. The stack of predetermined abstraction rules is customizable by the user so that speech data aggregates can be associated with different rules for display at different abstraction levels according to input of the user.

According to still another aspect of the present disclosure, new stacks are dynamically created from existing stacks, by at least one of inserting, deleting and changing an order of abstraction namers. Affected speech data aggregates are associated with a new stack when the user modifies the set of allowable transformations at run-time.

According to yet another aspect of the present disclosure, the transformations include initially reducing the data structure to a set of speech data aggregates at an elemental level of abstraction. All transformations also include combining data of speech data aggregates at the elemental level of abstraction to build at least one speech data aggregate at a higher level of abstraction, so that the visual representation of the data model includes only an elemental level of abstraction and a topmost level of abstraction.

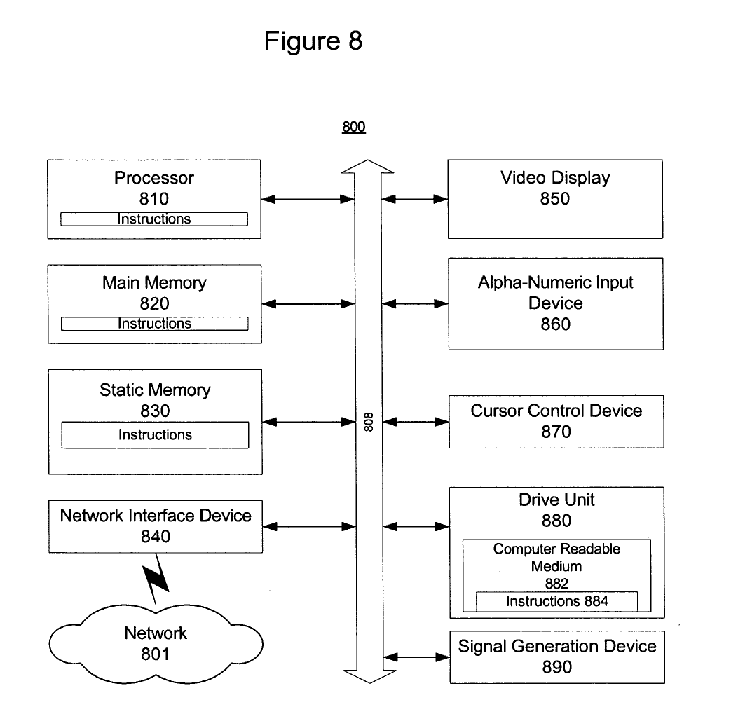

Referring to FIG. 8, an illustrative embodiment of a general computer system, on which automated interactive statistical call visualization using an abstractions stack model framework can be implemented, is shown and is designated 800. The computer system 800 can include a set of instructions that can be executed to cause the computer system 800 to perform any one or more of the methods or computer based functions disclosed herein. The computer system 800 may operate as a standalone device or may be connected, e.g., using a network 801, to other computer systems or peripheral devices.

In a networked deployment, the computer system may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 810, e.g., a central processing unit (CPU), a graphics processing unit (GPU), or both. Moreover, the computer system 800 can include a main memory 820 and a static memory 830 that can communicate with each other via a bus 808. As shown, the computer system 800 may further include a video display unit 850, such as a liquid crystal display (LCD), an organic light emitting diode (OLED), a flat panel display, a solid state display, or a cathode ray tube (CRT). Additionally, the computer system 800 may include an input device 860, such as a keyboard, and a cursor control device 870, such as a mouse. The computer system 800 can also include a disk drive unit 880, a signal generation device 890, such as a speaker or remote control, and a network interface device 840.

In a particular embodiment, as depicted in FIG. 8, the disk drive unit 880 may include a computer-readable medium 882 in which one or more sets of instructions 884, e.g. software, can be embedded. Further, the instructions 884 may embody one or more of the methods or logic as described herein. In a particular embodiment, the instructions 884 may reside completely, or at least partially, within the main memory 820, the static memory 830, and/or within the processor 810 during execution by the computer system 800. The main memory 820 and the processor 810 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 882 that includes instructions 884 or receives and executes instructions 884 responsive to a propagated signal, so that a device connected to a network 801 can communicate voice, video or data over the network 801. Further, the instructions 884 may be transmitted or received over the network 801 via the network interface device 840.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Using a general computer system as shown in FIG. 8, a user can obtain data visualization and visual querying in a speech domain specific adaptation. The data visualization and visual querying allows articulation of business requirements combined with technical knowledge of a speech development life cycle, recognition engine/application data and usage patterns.

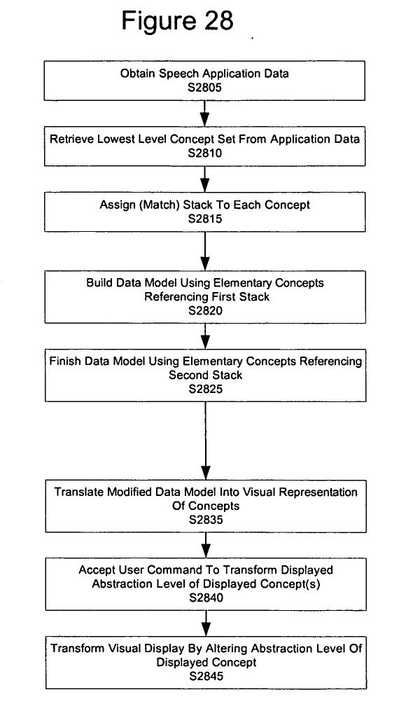

FIG. 28 shows an exemplary method for performing automated interactive statistical call visualization using abstractions stack model framework. As shown, speech application data is obtained at S2805. The speech application data may be retrieved from a memory based on instructions from a user. In an embodiment, the collected speech application data is data collected from an IVR relating to usage and operation of the IVR.

A set of lowest level (fundamental) concepts is retrieved from the application data at S2810, and a stack is assigned (matched) to each concept at S2815. The data model is built first using lowest level concepts referencing a first stack at S2820. For example, each concept that references a first stack may be a particular type of event that is recognized.

As explained below, the data model is built at S2820 using abstraction state definitions (naming logic) from at least one abstraction stack. Data from the set of concepts is used to create a new (higher) abstraction level that is higher than the initial (fundamental) abstraction level. For example, a concept at the new abstraction level may summarize the number of concepts at the fundamental level that indicate a user selected an option at a specified part of the call flow. In the embodiment of FIG. 28, the data model is modified in an initial stage when a data model is first built, in which case the data model is modified based on predetermined instructions (including initial instructions from the user). However, in another embodiment, the data model may be built at S2820 when a user issues a transformation command to transform a visual representation of a model being viewed.

The data model is finished using lowest level concepts referencing a second stack at S2825. As an example, each concept that references a second stack may be a different type of recognized event than the type of recognized events that reference the first stack.

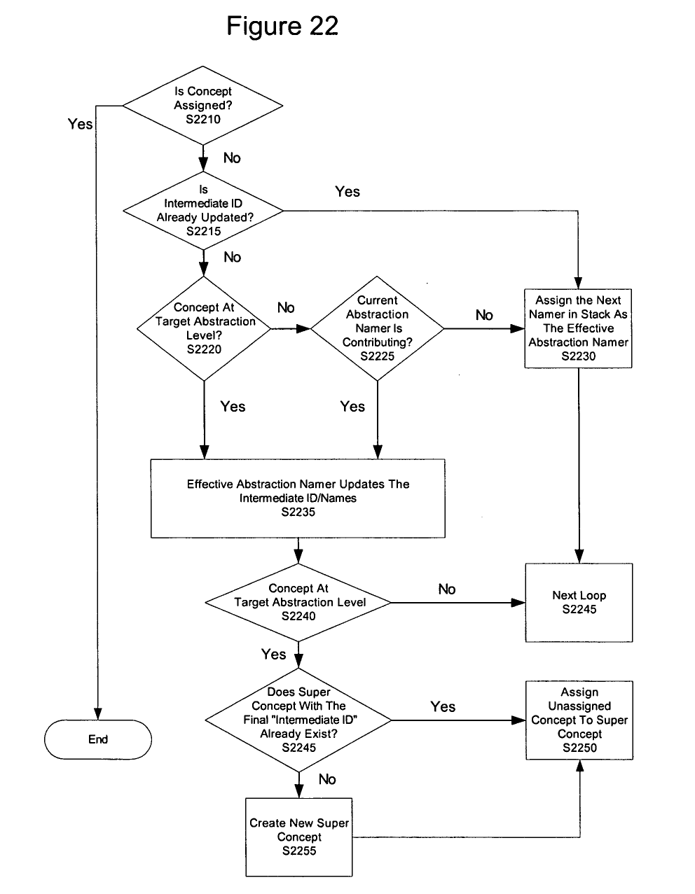

An exemplary method of building a data model is described below with reference to a recursive naming loop shown in FIG. 22. The data model is finished using the second set of core concepts at S2825. For example, each concept in the second set of core concepts may be designated as a connection between nodes for a visual representation to be constructed. In an embodiment, the first and second sets of core concepts correspond to system prompts, system events, user input and event outcomes.

The data model is translated at S2835 into a visual representation of the concepts to be displayed. At S2840, a user command to transform a displayed abstraction level of displayed concepts is accepted. The user may instruct a change in the displayed concepts using, e.g., a mouse, keyboard or other input device. The visual display is transformed at S2845 by altering abstraction levels of displayed concepts. As explained herein, when the displayed concepts to be transformed are in a higher abstraction state, the transformation involves deleting at least one concept in the visual model and building at least one new concept for the visual model.

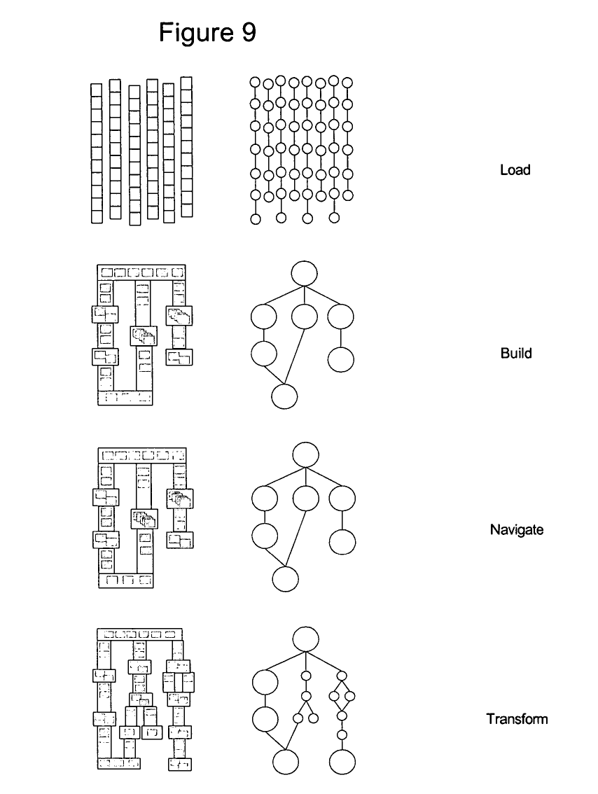

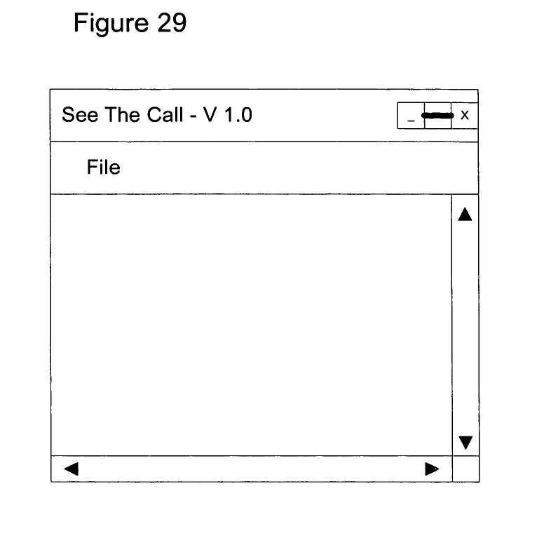

The software has four general phases of usage, namely load, build, navigate and transform. Exemplary models and visual facets corresponding to each of these phases are shown in FIG. 9. Exemplary screen-shots showing visualizations of each of these phases are shown in FIGS. 29-32. In the load phase, data is read from a data source. A simple model is built with the lowest abstraction level of concepts, where one call is not related to another. An exemplary screen shot corresponding to the load phase is shown in FIG. 29.

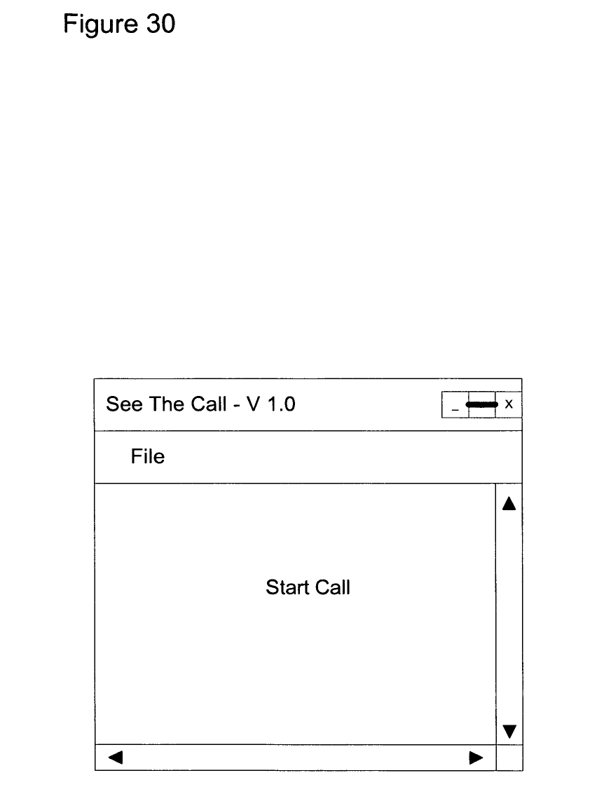

In the build phase, abstraction stacks (described below) are used to build higher level concepts so that the model reflects both the lowest abstraction concepts and the higher level concepts. In other words, relationships between low-level concepts are reflected in the higher level concepts built in the build phase using the abstraction stacks. As shown in FIG. 9, the visual facet in the build phase is different than the visual facet in the load phase. The visual facet in the build phase may be rendered on a screen, and the data may be ready for presentation in the navigate phase. An exemplary screen shot corresponding to the build phase is shown in FIG. 30.

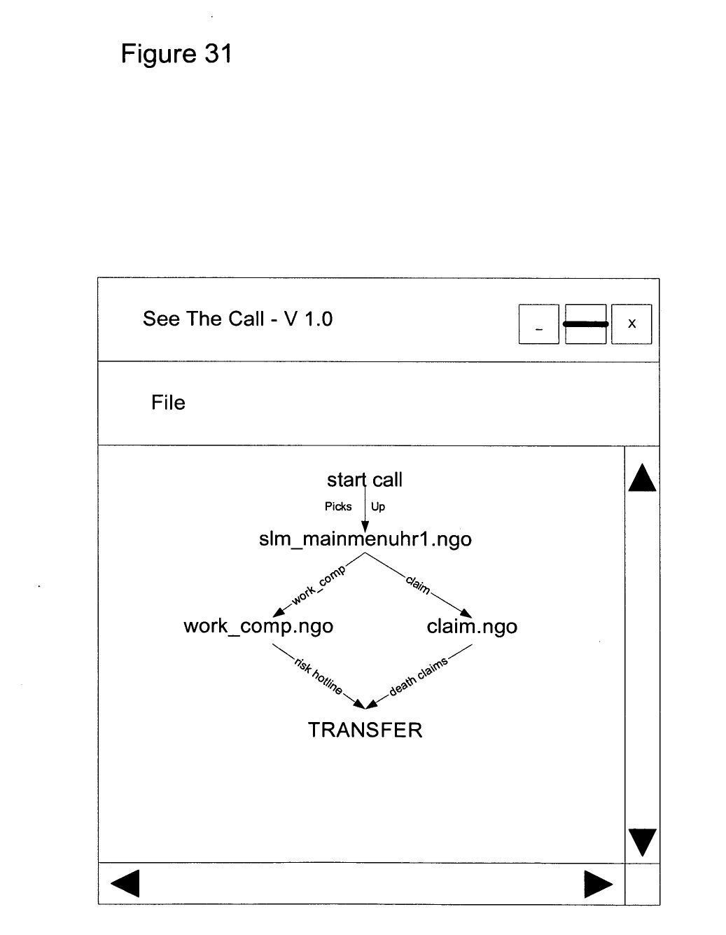

In the navigate phase, the user may expand and hide information from the facet. However, the navigation does not change the visual facet or the model. An exemplary screen shot corresponding to the navigate phase is shown in FIG. 31.

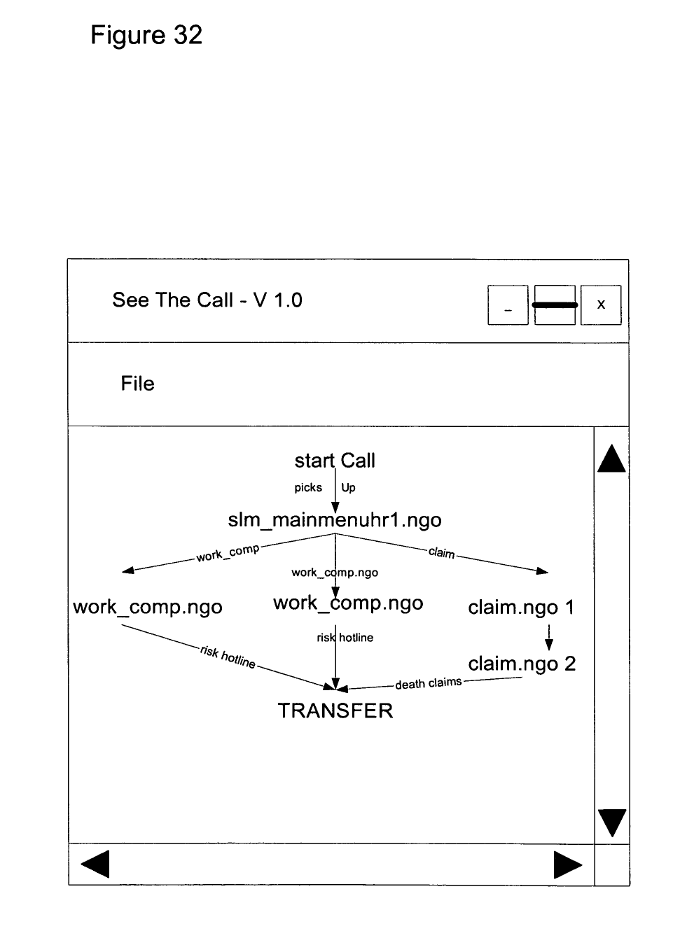

In the transformation phase, transformations are performed which change the model. Exemplary transformations include breakdown, split, combine and filter operations. An exemplary screen shot corresponding to the transformation phase is shown in FIG. 32.

The model is the heart of the architecture. The model is a collection of concepts representing call information. The concepts in the model are provided at various levels of abstraction and details. In the build and transform phase, computation is performed to determine which new concepts to create and which existing concepts to delete, based largely on the defined abstraction stacks. In the build phase, higher level concepts may be used to aggregate lower level concepts or to relate lower level concepts to each other. However, transformations may also result in higher level concepts being deleted. The visualizer translates the “topmost concepts” into nodes and edges in the visual facet. Not all nodes and edges are necessarily immediately shown to the user. However, users can readily expand or hide information contained in the facet through navigation. Transformations, on the other hand, are more intrusive types of operations, which will alter the model, resulting in changes in the set of the “topmost concepts”, and therefore in the nodes and edges in the visual facet.

The building block of a model is a concept. A concept is associated with generic attributes such as name, ID, type, abstraction and various facts. A concept can relate to another as a super concept, sub concept, pre-concept or post-concept. Through concepts, multi-to-multi relationships can be modeled as an edge in a node/edge model. The idea of concept avoids poorly coupled design where the visual presentation influences model design, and vice versa. An extreme case of a poorly coupled design would have the same node/edge object carry all model and visual attributes, resulting in the model object set being the same as the visual object set. As described herein, a decoupled software design allows for a wide variety of model/visual facet adaptations, including those set forth below.

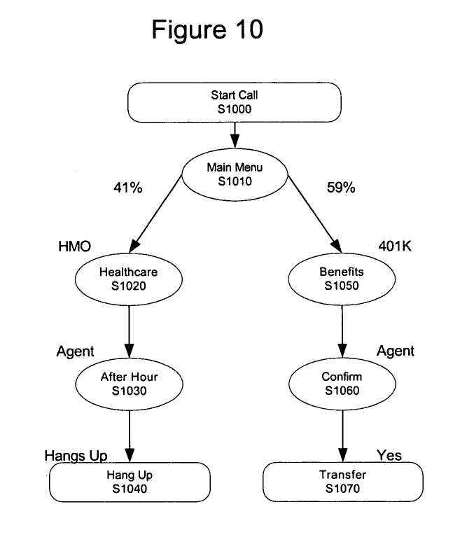

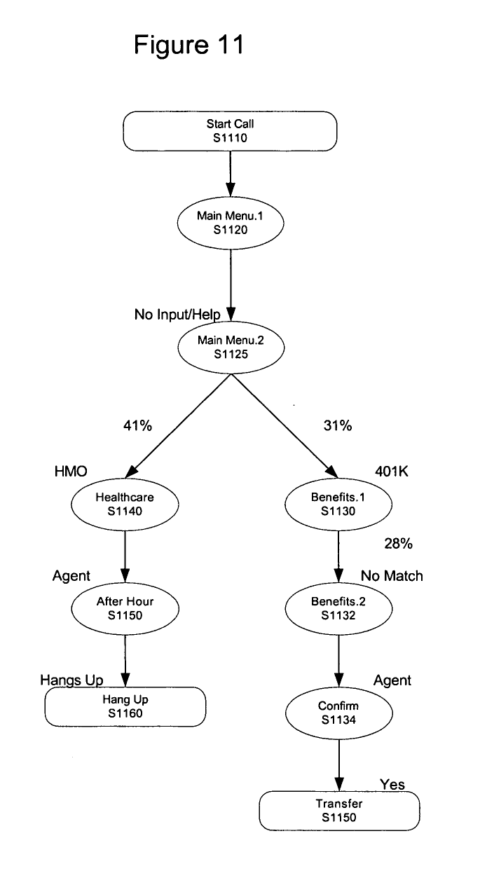

Statistics are omitted in FIGS. 10-27 for readability, although in practice statistics may be conveyed. FIG. 10 shows a call flow chart at a dialog state (level) abstraction. FIG. 11 shows several concepts at a sub-dialog state abstraction. Call information is grouped according to dialog state (system prompt), and user response. The model is then visualized as ellipses and arrows respectively. Events such as “start call”, “hang up”, and “transfer” are also incorporated and shown as rounded rectangles.

The diagrams in FIGS. 10 and 11 are system-centric. The system centric model takes two passes during build and transform. The first pass determines and builds system prompts, system events and/or system-centric mixed concepts. The second pass creates the user response and event outcome concepts as connections. In other embodiments, a model may be built in more than two passes based upon the building priority of the abstraction state. The examples shown in FIGS. 10 and 11 include statistics to illustrate how the models are used to present statistical breakdowns of information.

In FIG. 10, the call starts at S1000. At S1010 the user is prompted with the main menu. In one branch, the user is prompted with healthcare information or a healthcare menu at S1020. At S1030 the user is prompted with information that an agent is not available because the call is being made after hours. At S1040 the caller hangs up. In another branch, the user is prompted with benefits information or a benefits menu at S1050. At S1060 the user is prompted to confirm information, and at S1070 the call is transferred from the system. As should be clear, the nodes of FIG. 10 only show system prompts and system events.

In FIG. 11, the call starts at S1110. Two main menu prompts are shown at S1120 and S1125. The second main menu prompt at S1125 is shown because the user either provided no input or selected help at S1120. In one branch, the user is prompted with healthcare information or a healthcare menu at S1140. At S1150 the user is prompted with information that an agent is not available because the call is being made after hours. At S1160 the caller hangs up. In another branch, the user is prompted with benefits information or a benefits menu at S1130 and S1132. The user is prompted to confirm a selection at S1134. At S1150 the call is transferred from the system. As should be clear, the nodes of FIG. 11 only show system prompts and system events.

The difference between FIGS. 10 and 11 is primarily in the break-out of information for main menu prompts at S1120 and S1125 and for benefits prompts at S1130, S1132 and S1134. FIG. 11 shows the dialog level broken out into a sub-dialog level for the nodes at S1010 and S1050 in FIG. 10. By comparison, FIG. 10 shows the information from the sub-dialog abstraction level at S1120 and S1125 as a higher dialog abstraction level summary at S1010.

The concepts in FIGS. 10 and 11 may be described as system-centric “mixed” concepts. System-centric mixed concepts do not contain only system prompts or system events. Rather, system-centric mixed concepts also encapsulate links between user response and event outcome concepts. For example, the main menu and benefits dialog state concepts at the top in FIG. 11 contain, e.g., “no input”, “help” and “no match”, though each of these are user response concepts.

Although not shown, the model is also structured so that system prompts and system events never link directly to each other at the lowest call interaction level. Rather, system prompts and system events link to each other through user response or event outcome. For example, when there is no meaningful concept between two system events, a placeholder concept is created to bridge the two. The placeholder concept has statistics, and behaves just like any user response concept, and is different than an empty arrow in the unstructured diagrams (also known as empty arrow diagrams).

Two initial abstraction stacks are defined for the applications shown in FIGS. 10 and 11. A system prompt/system event stack includes call interaction, sub dialog state—(flow aware), dialog state—(flow aware), and a component. A user response/event outcome stack includes call interaction, statistics stratification—unique user response, and a link group. In other words, the two stacks define abstraction states for the information shown in FIGS. 10 and 11. System prompts and system event/mixed concepts are built and transformed first according to a build priority, and any unassigned user response/event outcome concepts are built and transformed second.

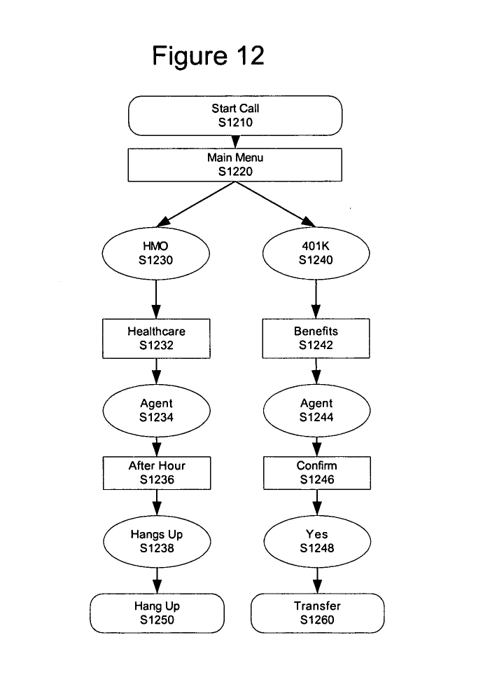

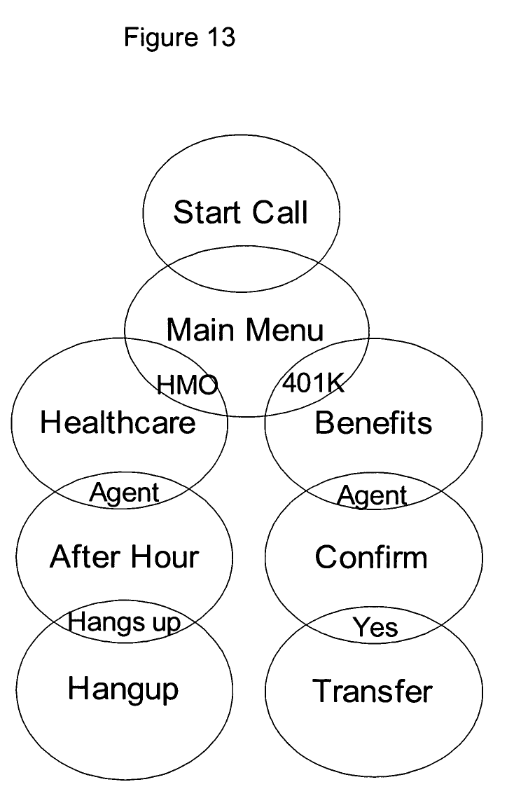

FIGS. 12 and 13 are two visual variations of the same class application as shown above in FIGS. 10 and 11. The data model of the two diagrams in FIGS. 12 and 13 are exactly the same as the models of the diagrams in FIGS. 10 and 11.

In the empty arrows variation shown in FIG. 12, no concept is mapped to an arrow, such that the empty arrows serve purely as a visual linking aid, with no call properties (or statistics). The user responses represented as arrows above are now elliptical nodes. A call starts at S1210 and the main menu prompts are played at S1220. In a first branch, the user selects an “HMO” option at S1230 and the healthcare menu prompts is played at S1232. The user selects an “agent” option at S1234, and is informed at S1236 that an agent is unavailable because the call is made after hours. The user hangs up at S1238 and the system hangs up at S1250.

In the other branch, the user selects “401K” at S1240 and benefits menu prompts are played at S1242. The user selects an “agent” option at S1244 and is prompted to confirm the request at S1246. The user confirms the request at S1248 and the call is transferred at S1260.

The Venn visualizer variation shown in FIG. 13 is even more similar to the user-centric flow aware diagram shown in FIG. 10. The visual facet object mapping in FIG. 13 is identical to the visual facet object mapping in FIG. 10, and only the visual rendering method is different. Accordingly, the use of generic concepts and a distinct visualizer layer provides flexibility.

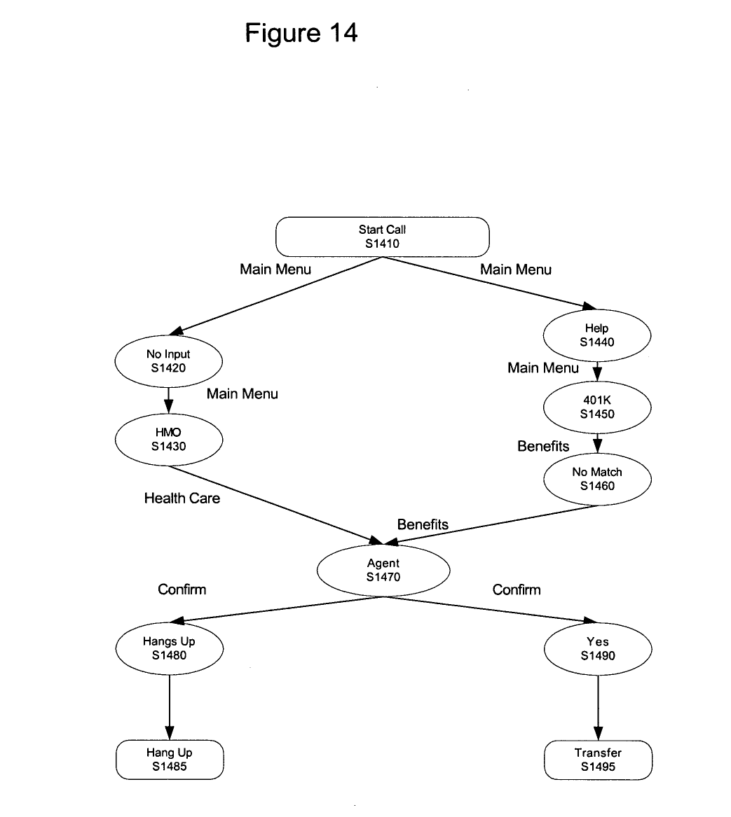

FIG. 14 shows a diagram which puts user responses in focus. The underlying business theme of a diagram such as the one shown in FIG. 14 is to understand prompts and events that invoke similar user responses or behaviors. In these diagrams, user responses are represented by nodes, and system prompts are represented by arrows. System events are still represented by nodes, as events are neutral for both the user and the system from an analysis perspective.

The call starts at S1410. In one branch, no input is received at S1420 and the user selects an “HMO” option (played from main menu prompts) at S1430. The user selects an “agent” at S1470. In the other branch, the user selects “help” at S1440 and a “401K” menu at S1450. Any user input at S1460 is classified as “no match”. The user selects an “agent” at S1470. In the first branch, the user hangs up at S1480 and the hang up is confirmed at S1485. In the other branch, the user enters “yes” at S1490 and is transferred at S1495.

Just like the user-centric flow aware diagram shown in FIG. 10, the diagram in FIG. 14 can easily be implemented as either structured or unstructured. In a structured user-centric model, a user response/system event must be followed by a system prompt/event outcome. In the unstructured model, a user response can be adjacent to another user response or system event. If one examines the underlying unstructured model for the diagram in FIG. 14, the “hangs up” elliptical node should be adjacent the “hang up” rounded square node, with no concepts in between. The “yes” elliptical node should be adjacent to the “transfer” node. Accordingly, the bottom two arrows in FIG. 14 are empty arrows, with no underlying concepts.

The stack definition and build/transform order is the opposite of the system centric diagram. The only difference between FIGS. 11 and 14 occurs if a particular type of concept is associated with a different stack. In other words, two abstraction stacks are initially defined. A system prompt/event stack includes call interaction and a link group. A user response/event outcome stack includes call interaction, a sub dialog state (flow aware), a dialog state (flow aware), and a component. User response/event outcome concepts are built and transformed first, and any unassigned system prompt/event concepts are built and transformed second.

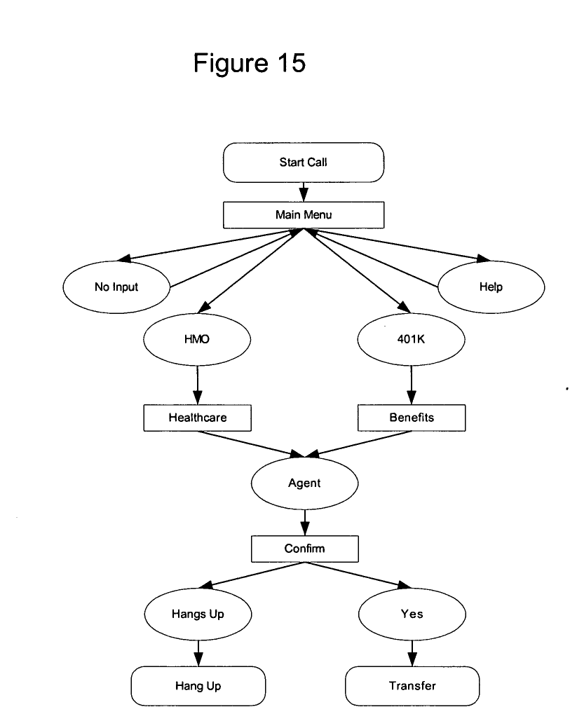

FIG. 15 shows a neutral diagram which treats all call interactions identically. In the neutral diagram, there is no particular build order by concept types. In the diagram, arrows are empty arrows, ellipses are user response concepts, rounded rectangles are events and rectangles are system prompts. Each user response, system prompt, system event or event outcome concept can have multiple previous or next concepts. This is different for user-centric or system-centric diagrams, where particular concept types are treated as link concepts, and can only have one previous and one next concept.

In the system centric and user centric stack, a “sub dialog state—(flow aware)” abstraction state is defined. This abstraction layer looks ahead and compares whether the same concept type repeats itself, and categorizes consecutive concepts having the same key value with different names such as “main menu. 1” and “main menu.2”.

In the neutral diagram stack, the “sub dialog state—(flow aware)” abstraction definition is removed. Therefore, at the dialog state level abstraction, even though “no input” and “help” are both sandwiched between main menu prompts, these concepts are not summarized under the main menu concept. This establishes neutrality since one concept type does not dominate another. Since the building process does not traverse related concepts beyond the immediate siblings, any diagram that does not have a flow aware abstraction is considered flow-unaware.

Two abstraction stacks are initially defined. A system prompt/event stack includes call interaction and a dialog state. A user response/event outcome stack includes call interaction and a dialog state. Further, there is no build priority order for the neutral diagram shown in FIG. 15.

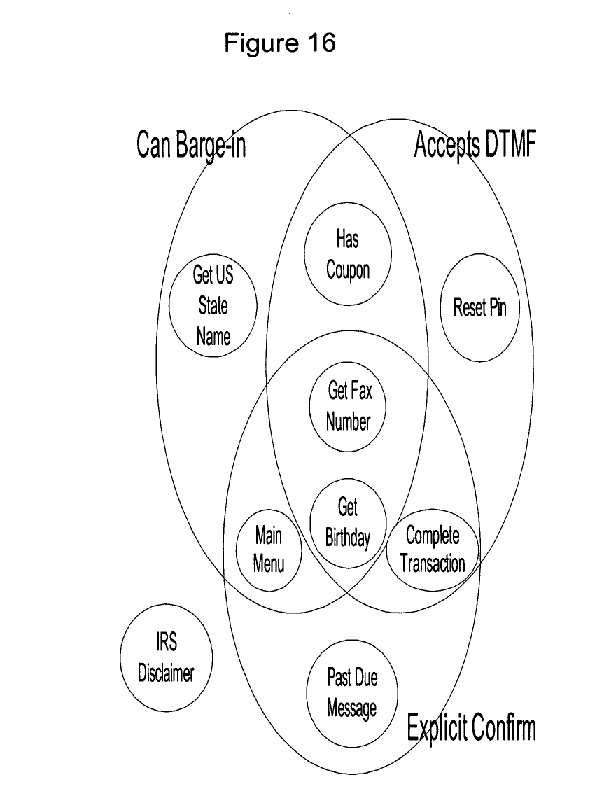

FIG. 16 shows a diagram that uses a stack that filters out non-system-prompt-type concepts, and a visualizer that diagrams according to the aggregate statistics. If a dialog state concept has any sub concepts with the “barge-in” flag, then that dialog state is considered “can barge-in”, etc. The Venn visualizer then places the dialog state according to the statistics, and ignores relationships to sibling concepts. The three big circles are only visual aids, and are not mapped to any concepts, unlike the mapped system prompt ellipses.

Each abstraction stack is initially defined using call interaction, filter—no confirmations, filter—“system prompt” type concepts, and a dialog state.

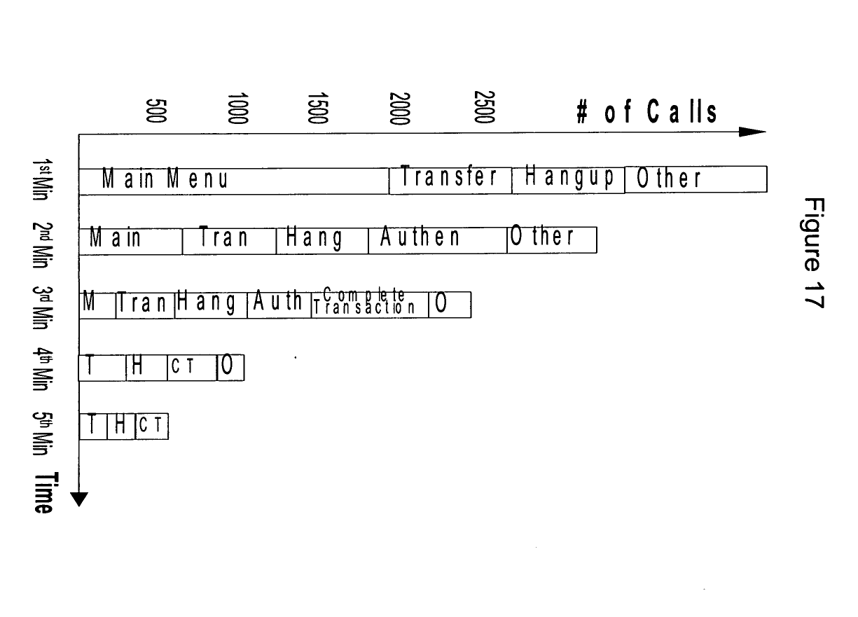

FIG. 17 shows a diagram which uses a flow aware statistics abstraction that categorizes concepts according to time elapsed and the dialog state name at the minute mark (or, if the call ended within that minute, the last interaction name). The visualizer is a typical bar charter.

Each abstraction stack is initially defined by filtering call interaction concepts for system prompt-type concepts. Statistics are stratified by duration-thus-far statistics (at the minute), a dialog state, and a component group. The component group may be e.g., non-main menu components and/or transfer components, designated as “others”.

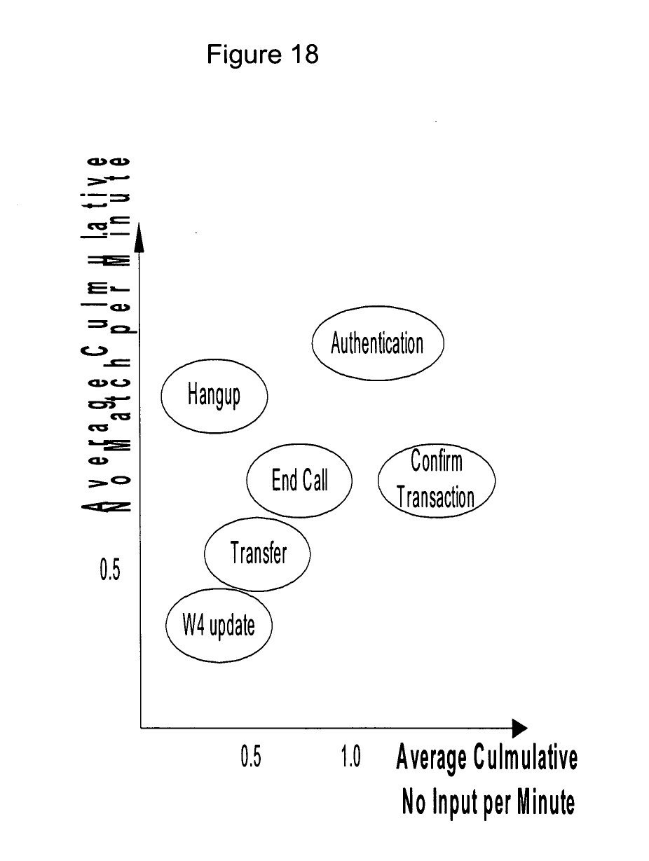

FIG. 18 shows a diagram which charts based on two cumulative statistics. Each abstraction stack is initially defined using call interaction, filter—“system prompt” type concepts, and a dialog state.

Although the program is called automated call visualization, the visualizers are the least complex of the software architecture components, if the model and the associated operations are well-designed. The abstraction stacks architecture allows users to mix-and-match different abstractions to achieve an impressive array of models, with inherent reversible transformation operations, and many statistics, visual facet updates and other built-in features.

For the user-centric flow aware diagram, at load and build time, there are two initial stacks, one for the system prompts/system events (stack A hereafter), and one for the user response/event outcomes (stack B). In addition to the initial build stacks, when users perform certain transformations, new stacks are also created during run time. During the load phase, as concepts are created, they are assigned one of the initial stacks. Each initial stack is associated with matching functionality which will return true or false when the model tries to match the newly loaded concepts with a stack. When a stack is first matched to a concept, the stack is also free to assign facts or alter attributes to the new concepts, such as the concept name, concept type, and concept abstraction (set at “call interaction”, the lowest abstraction initially). At this point, the load phase is finished and all new call interaction concepts are in an “unassigned” state.

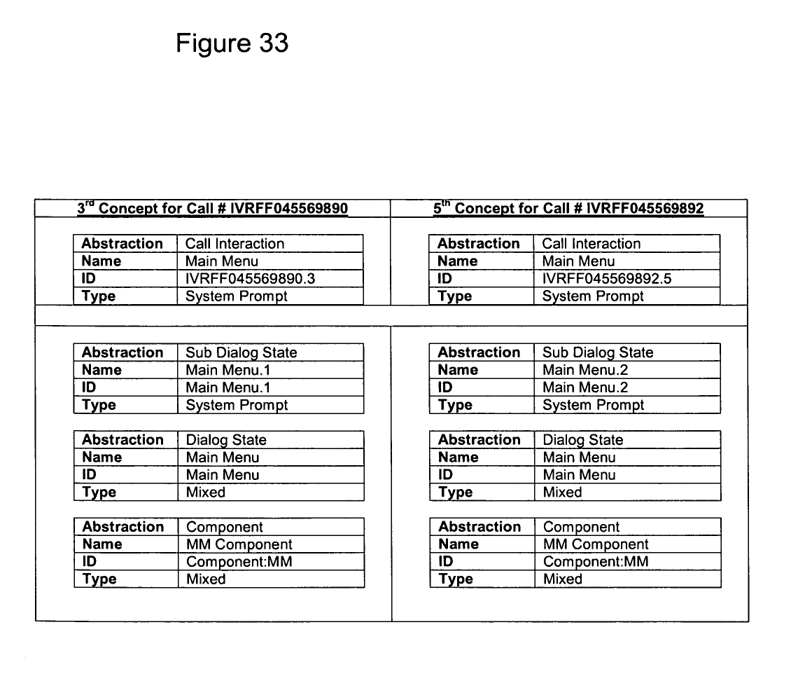

After the load phase comes the build phase. Each type of diagram has a target abstraction when it is first presented to the user. For example, in the first user-centric flow aware diagram example when the user views the initial screen, stack A concepts are built to the dialog state level, while the stack B concepts are built to the link group level. The model will go through all of the unassigned concepts, and then identify the correct super concept at the target abstraction, using the associated stack. An example of the corresponding super concepts for two different concepts and for two different calls are shown in the table in FIG. 33.

Note that if the target abstraction is call interaction, there is no associated super concept, since call interaction is the lowest level concept, and they are already at the target abstraction.

When the diagram is first presented to the user at the call dialog state abstraction, both concepts will be represented by the same main menu dialog state concept, and their statistics will be combined. However, if the user performs the “break down” transformation on the main menu dialog state concept to the sub dialog state level, then the two concepts will be grouped under different concepts, main menu.1 and main menu.2 namely.

As illustrated in the example shown in FIG. 33, the main job of an abstraction stack is to determine the name and ID of the super concept to which a particular concept belongs, at the target abstraction level. More exactly, a stack is composed of abstraction namers. As previously noted, each abstraction namer has an algorithm to determine the name of the associated super concept(s), for any unassigned concept, using the concept's attributes and facts. At the time the name and ID of the super concept is determined, it does not mean the concept is already created. In fact, the model has logic to build new concepts if the named one does not already exist. The naming process allows for multiple named super concepts. In other words, a concept can also belong to multiple super concepts, although none of the illustrated diagrams above fit this description.

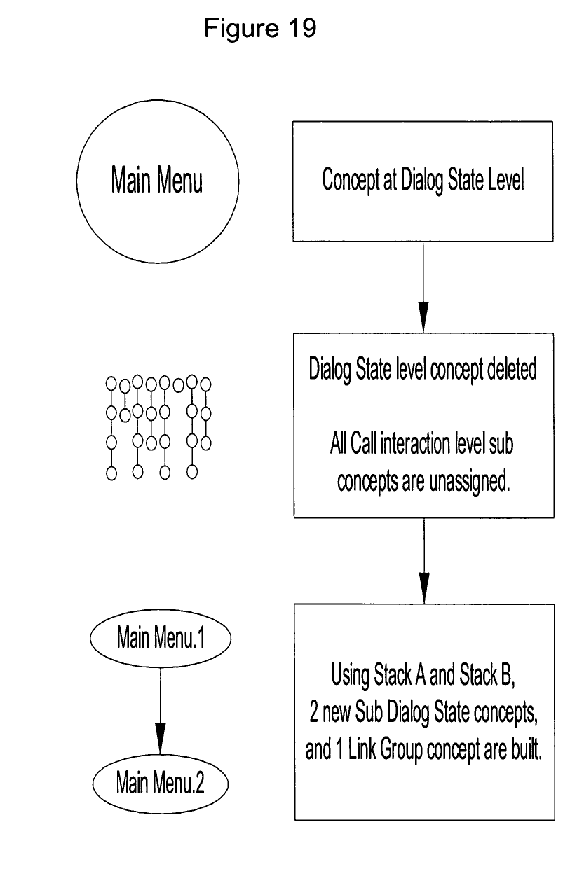

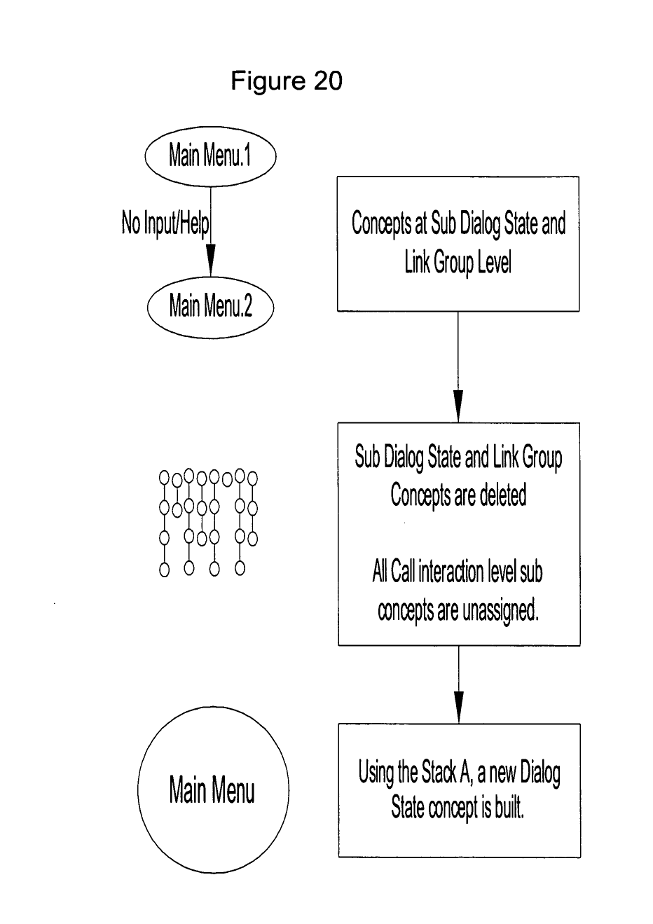

The models built from this approach are called “thin”. This means if the target abstraction level is “component”, then the immediate sub-concepts would be at the call interaction abstraction. There is no dialog state or sub dialog state concepts in-between. This tremendously simplifies many transformation processes. Moreover, any transformation, just like the build process, starts from the ground up. This means when a super concept is broken down into a lower level concept, the super concept itself is deleted, and then all sub concepts, which are the lowest level call interaction concepts, are built to another target level from the “ground up”. The same applies if a set of selected concepts were to be elevated at a higher abstraction, the entire set of selected concepts would be deleted, and all sub-concepts would be built from the “ground up” also. FIG. 19 shows an illustration of breaking a target dialog state abstraction to a sub-dialog state abstraction. FIG. 20 shows an illustration of building a sub-dialog state abstraction up to a dialog state abstraction.

Another important implication of the “ground up” building is that all operations are reversible, and there is no need to define undo-operations, or consume considerable system resources remembering previous application states. As a result, go-back and undo features are relatively easy to implement.

Moreover, just because the concepts model is thin, this does not mean the in-between abstraction namers are not utilized. In fact, certain advanced abstraction namers always contribute in the naming process, even though they are not the target abstraction. Take the following simple 4 layer stack as an example: 1. call interaction; 2. statistics stratification—duration-thus-far; 3. statistics stratification—barge-in; and 4. dialog state.

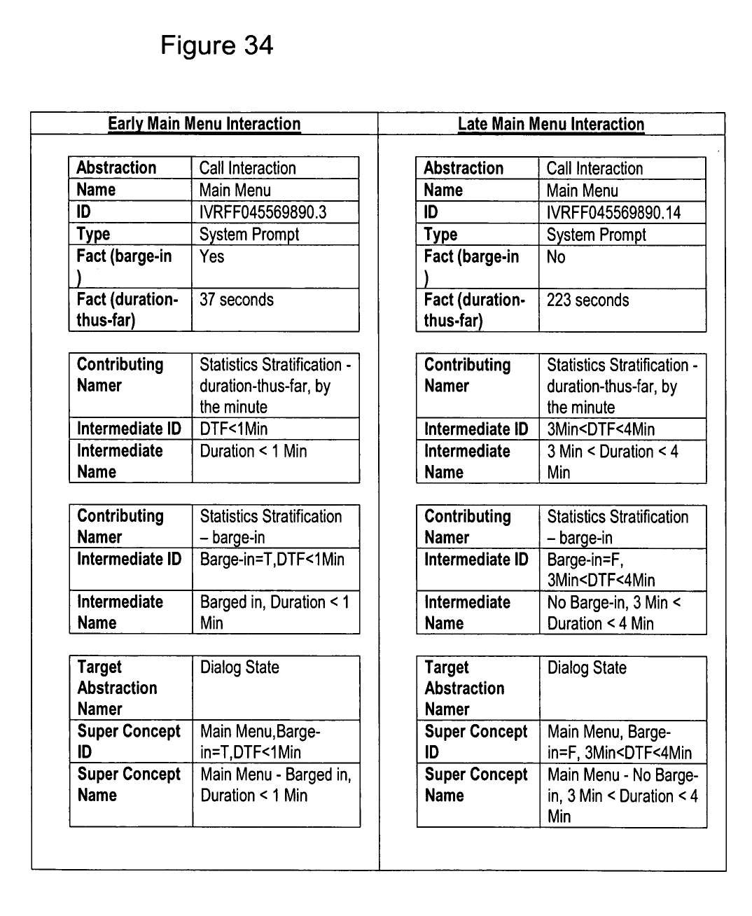

Two different main menu prompt call interactions from the same call, one early in the call and one much later, where the target abstraction is a dialog state, are shown in the table in FIG. 34.

The namer aspect of the design forces model designers to assign specific names to each group of concepts (super concepts). This automatically allows for easy concept referencing, not just in a particular application instance, but across different data sets and sessions. In an application that is transformed to templates, users can “record” all the navigations and transformations leading up to a certain diagram or statistics snapshot, and then apply the same steps to a different data set. All possible operations are those already defined in the stacks and all potential sets of new abstraction namers, so operations can also be simply captured. Named operations and target concepts together allow for simple templatization, with low storage requirements. In the examples above, all the “in-between” abstraction namers are contributing, but this is not required in every case.

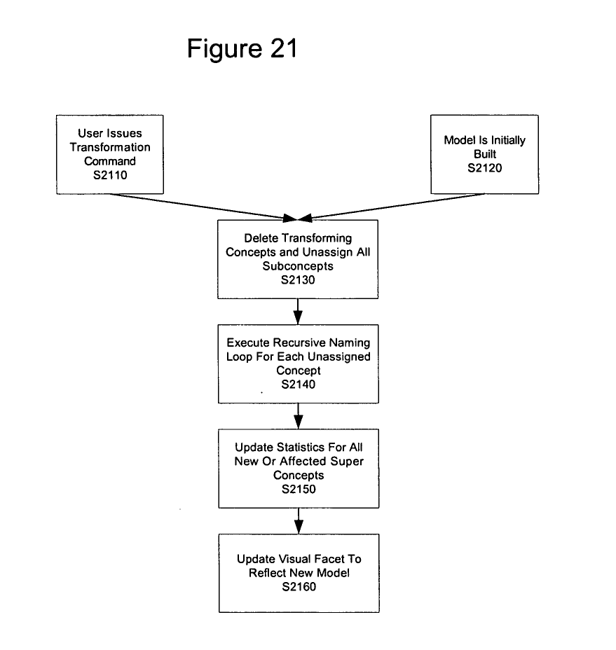

A simplified flow of the super concept naming process is shown in FIGS. 21 and 22. The simple design shown in FIGS. 21 and 22 provides common procedures that all models may perform, so model designers can focus on the application logic, i.e., the naming algorithm. Therefore, generalization is supported for build and transformation, leaving the operations specific to an abstraction to the abstraction namer's naming logic. There are also advanced namers, such as filter namers, statistics namers, flow-aware namers and component namers, which can be used to implement uncommon applications and complex build/transform logic. In the “recursive naming loop”, the first two segmentation decisions, i.e., “is concept assigned?” and “is intermediate ID already updated?” allow for filter and flow aware namers to by-pass the build algorithm.

As shown in FIG. 21, a user issues a transformation command at S2110. Alternatively, a model is initially built at S2120. In either case, transforming concepts are deleted and all subconcepts are unassigned at S2130. A recursive naming loop is executed for each unassigned concept at S2140, and statistics are updated for all new or affected super concepts at S2150. The visual facet is updated to reflect the new model at S2160.

At FIG. 22, a determination is made at S2210 whether a concept is assigned. If the concept is assigned (S2210=Yes), the process ends. If the concept is not assigned (S2210=No), a determination is made at S2215 whether an intermediate ID is already updated for the concept. If the intermediate ID is not already updated for the concept (S2215=No), a determination is made whether the concept is already at a target abstraction level at S2220. If the concept is not at a target abstraction level (S2220=No), a determination is made at S2225 whether a current abstraction namer is already contributing. If the concept is already at the target abstraction level (S2220=Yes), or the current abstraction namer is contributing (S2225=Yes), the effective abstraction namer updates the intermediate ID/Names at S2235. If the intermediate ID is not already updated (S2215=Yes), or the current abstraction namer is not contributing (S2225=No), the next namer in the stack is named as the effective abstraction namer at S2230.

Following the updating of intermediate ID/names at S2235, a determination is made at S2240 whether a concept is at a target abstraction level. If the concept is not at the target abstraction level (S2245=No), or after the next namer in the stack is assigned as the effective abstraction namer at S2230, the next recursive naming loop is performed beginning at S2245.

If the concept is not at the target abstraction level (S2240=Yes), a determination is made at S2245 whether a super concept with the final “intermediate ID” already exists. If the concept with the final “intermediate ID” does not already exist (S2245=No), a new super concept is created at S2255. If the concept with the final “intermediate ID” does already exist (S2245=Yes), or after a new super concept is created at S2255, an unassigned concept is assigned to a super concept at S2250.

Throughout the build and transform process, new concepts are added and old ones are deleted. As the new model is rebuilding, it keeps track of concepts that are relevant to the visual facet, and provides the visual facet with an updated list of concepts. The concepts carry flags such as “marked for delete”, “active”, “binded” and other flags, which signal the facet to adjust its visual objects accordingly.

Under the abstraction stack paradigm, good name space management is provided by good stack design. The following two naming commands refer to the same link group concept:
link group (main menu [repeat 1], main menu [repeat 2]) main menu.1ˆmain menu.2

Since the model uses the ID as a primary key, both of the syntaxes above would uniquely identify the same link group concept. Obviously, proper definition of special symbols and syntax improve understanding, but one should also be careful of other namer's conventions, to avoid confusion.

Statistics namer is a versatile class of namers. Statistics namers are used to illustrate how and why new stacks are built during run time.

Any call interaction concept carries a wide array of recognition and call information called facts, such as duration, barge-in, dual tone multifrequency (dtmf) and other attributes. When super concepts are built, facts are combined to form higher level statistics, such as average duration, and barge-in rate. It is natural for a user to group/segregate information according to those statistics. For example, the user might look at a user-centric flow aware diagram at the dialog state level, and want to see how the user experience differs for users who stay on the call over 3 minutes. Under the stack framework, this is the same as adding another abstraction, which groups concepts by the duration statistics. Since the original stacks do not define this statistics abstraction, a new stack will be replicated with the new abstraction (stack C): call interaction; sub dialog state—(flow aware); dialog state—(flow aware); statistics—duration, over 3 minutes; and component.

All super concepts that the user has selected to go through this operation will be deleted, and their sub concepts will be matched in the new stack C, with the target level abstraction as “statistics—duration over 3 minutes”, and the typical ground-up building process will commence. One can add as many of these statistics namers, at different levels, to different groups of concepts (which will have different stacks), to achieve advanced hybrid stratification diagrams.

Statistics Namer is not limited to grouping by facts, but all attributes in the concept, such as name, ID, type, prev/next/sub/super concepts. In fact, many simple namers such as the flow-unaware dialog state namer and “statistics—unique user response” namer, are just special cases of the Statistics Namer.

Of course, for users to have real time access to flexible statistics grouping, the visualizer should have an interface that allows users to pick and choose various statistics/facts/attributes, to define the new namer. Such an interface (e.g., keyboard, touch-screen, mouse-controlled cursor) is easily implemented, and description thereof is intentionally omitted herein.

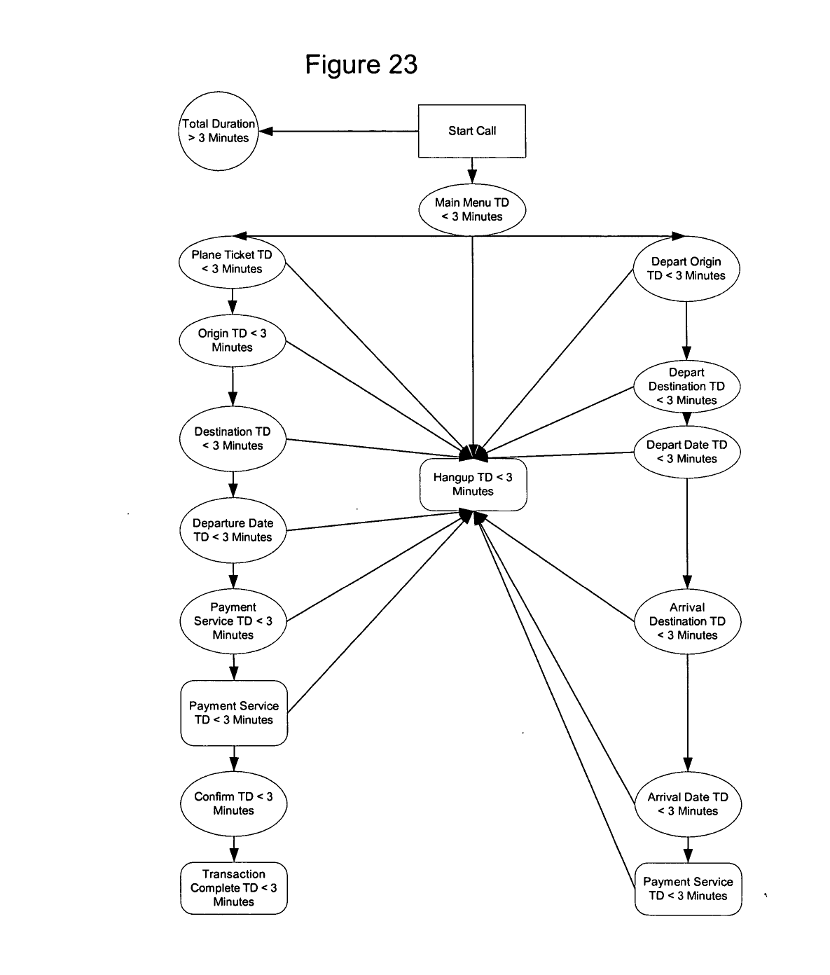

An exemplary diagram built with stack C, broken down at different levels is shown in FIG. 23.

A component namer may be an aggregate of simple naming rules, usually with custom or application-specific values. For example, a component namer used to group application modules is shown below:

| Fact to Match | Match Pattern | Super Concept ID |
|---|---|---|
| Grammar Name | w4*ngo | W4 Module |
| Grammar Name | *tax*ngo | W4 Module |
| Grammar Name | slm_mainmenu.ngo | MM Module |
| Grammar Name | mm_disambig* | MM Module |
| Event Name | *SPEAKER*VERIF* | Authentication App. |
| <others> | * | Other Modules |

The component namer is created to allow for easy definition of application specific layers, where the designer or user can define the rules through a table or configuration file, instead of writing code.

Filter namers virtually reduce/increase the number of atomic concepts in the model, or present a significantly different reality. A filter namer is typically used to “remove” confirmation concepts, or concepts of certain types, to simplify the initial diagram, while allowing real time expansion of those hidden concepts if the user desires. Filter namers are always contributing, and are usually placed right above the lowest level abstraction namer. This allows the filter namer to filter, before the actual super concepts calculation happens in later namers. The key method to remove concepts is to mark them as assigned, which effectively discontinues the naming process, and that particular concept will not be accounted for in any super concepts.

Filter namers are a slightly more complex than flipping the assigned flag. First, the pre-confirmation concepts reconnect to the post confirmation concepts, and the duration and other cumulative statistics should be added also to later concepts. The filter namers almost always adjust facts in the affected concepts, and store the original values with a new mirror set of facts. Then when the user decides to remove the filtering, the original values will be restored, including the original connections. When the user decides to remove the filtering, a new stack will be built, with one less layer of abstraction, which is the opposite of transformations which create bigger stacks.

Since filter namers are used to change the underlying model, architects should consider whether using a different loader is more appropriate. For example, a filter namer can be used to convert a state-flow diagram, into a time-flow diagram, just like the bar-chart diagram presented in earlier sections. However, if the model is completely reconstructed, and the bar-chart diagram does not need to revert to the underlying model, it may be beneficial to use a different loader that creates the atomic concepts correctly. The decision between a filter namer and a loader should be whether the altered abstraction should be undone during run-time, and if the filter namer is significantly easier to write/understand.

All namers described above take one unassigned concept at a time and group according to its attributes alone. However, in flow-diagram applications, at certain abstractions, it is critical and significantly more efficient to traverse through all previous and next concepts in a call. In those cases, the flow-aware namer is free to move ahead/backward to other unassigned concepts, to update all the intermediate names at once. When the build process encounters an unassigned concept, whose name has already been updated, then it would skip the naming process, and proceed to the next contributing namer for that concept.

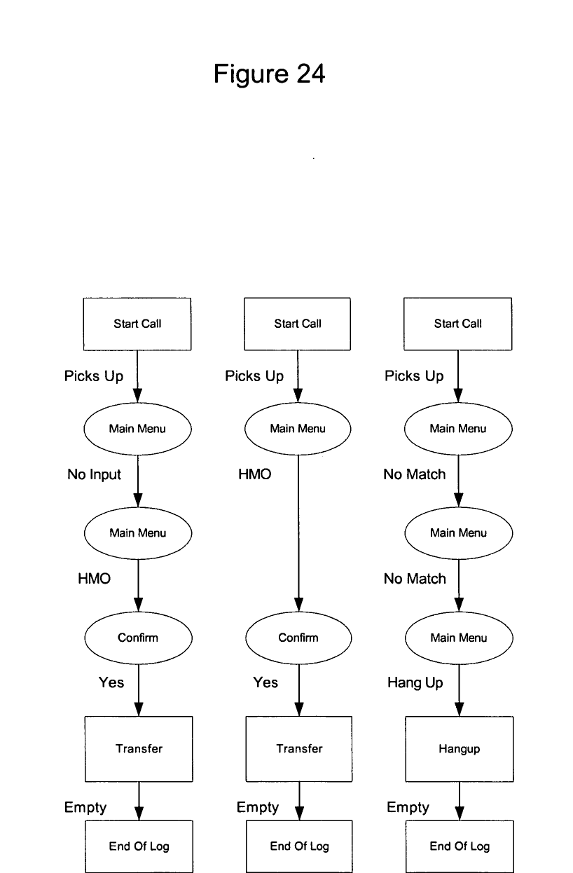

A dialog state concept is a collection of call interaction concepts that share the same system prompt or system event. Three exemplary separate calls at the call interaction abstraction are shown in FIG. 24.

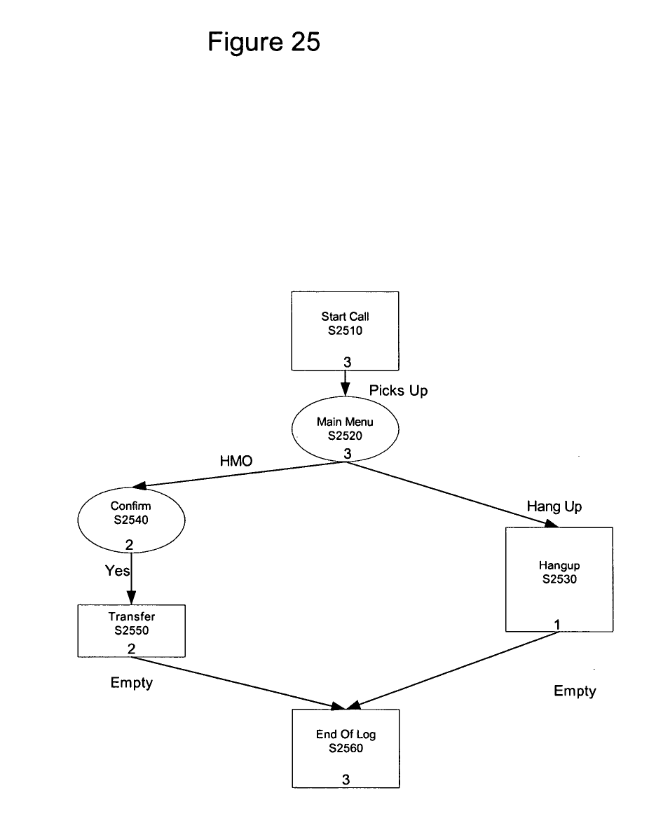

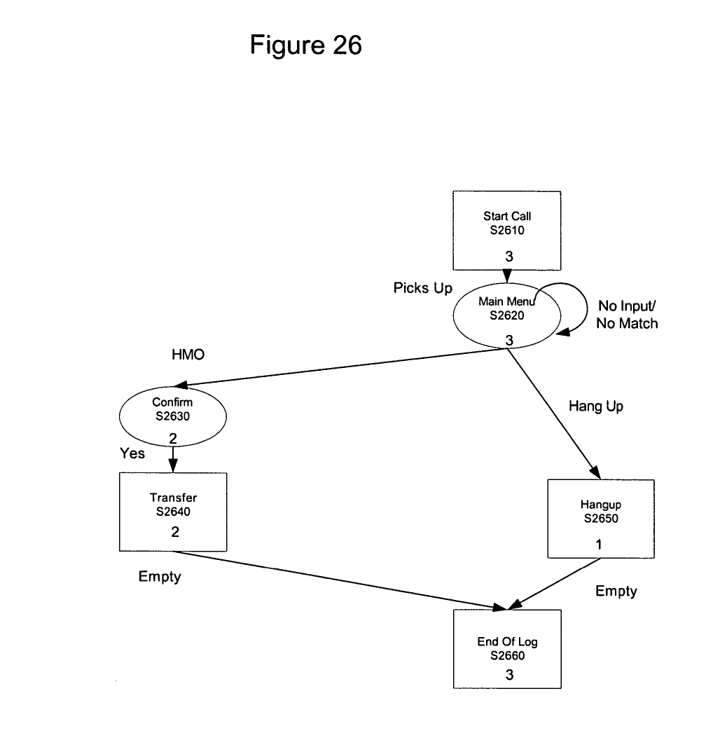

FIGS. 25 and 26 show an illustration of the difference between the manner in which a flow-aware and a flow-unaware dialog state namer are used. The lower case numbers (i.e., “1”, “2” or “3”) indicate the number of unique calls in an abstraction for ease of understanding. In FIG. 25, the call starts at S2510 and the main menu prompts are played at S2520. In one branch, at S2540 the user is prompted to confirm a selection, and the user is transferred at S2550. In the other branch, the system hangs up at S2530. In each branch, the call log ends at S2560.

The dialog states in a flow aware diagram treat all concepts between system prompts with the same name as one dialog state. The “main menu” dialog state concept on the left may encapsulate multiple “main menu”, “no input” and “no match” call interaction abstraction concepts from the three calls. The main menu dialog state abstraction concept is a mixed type concept, since it contains a mix of system prompts and user response type concepts. On the other hand, in the flow unaware diagram, each system prompt occurrence is independent of others, so a “no input” event from main menu going into main menu is not included in the main menu concept itself. That does not only affect the visual presentation and understanding, but also statistics.

In FIG. 26, the call starts at S2610, and main menu prompts are played at S2620. In one branch, the user is prompted to confirm a selection at S2630 and the call is transferred at S2640. In the other branch, the system hangs up at S2650. The log ends for both branches at S2660.

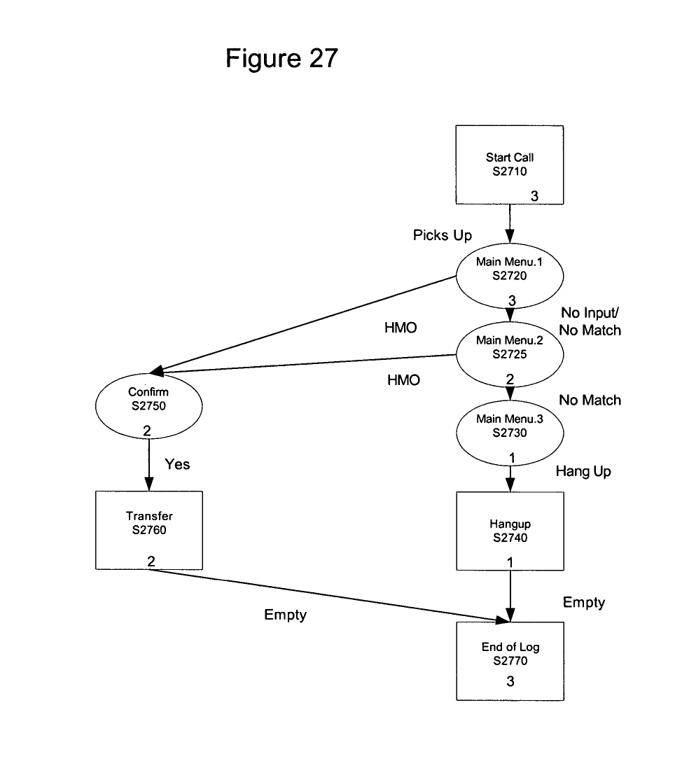

The flow aware dialog state abstraction diagram shown above is a user-centric flow aware diagram rendition, where all interactions with the same system prompt/event are encapsulated in one concept, regardless of how many attempts a caller made, in order to try to get past that system prompt/event. An abstraction unique to this design, called the sub dialog state abstraction is created for that purpose. The diagram shown in FIG. 27 illustrates the result that occurs when the “main menu” dialog state concept is “broken down” to the sub dialog state abstraction.

In FIG. 27, the call starts at S2710. Main menu prompts are played at S2720, S2725 and S2730. At S2750, the caller is prompted to confirm a selection, and the call is transferred at S2760. The system hangs up at S2740 following a determination that the user has hung up. Each branch in FIG. 27 ends with an “end of log” at S2770.

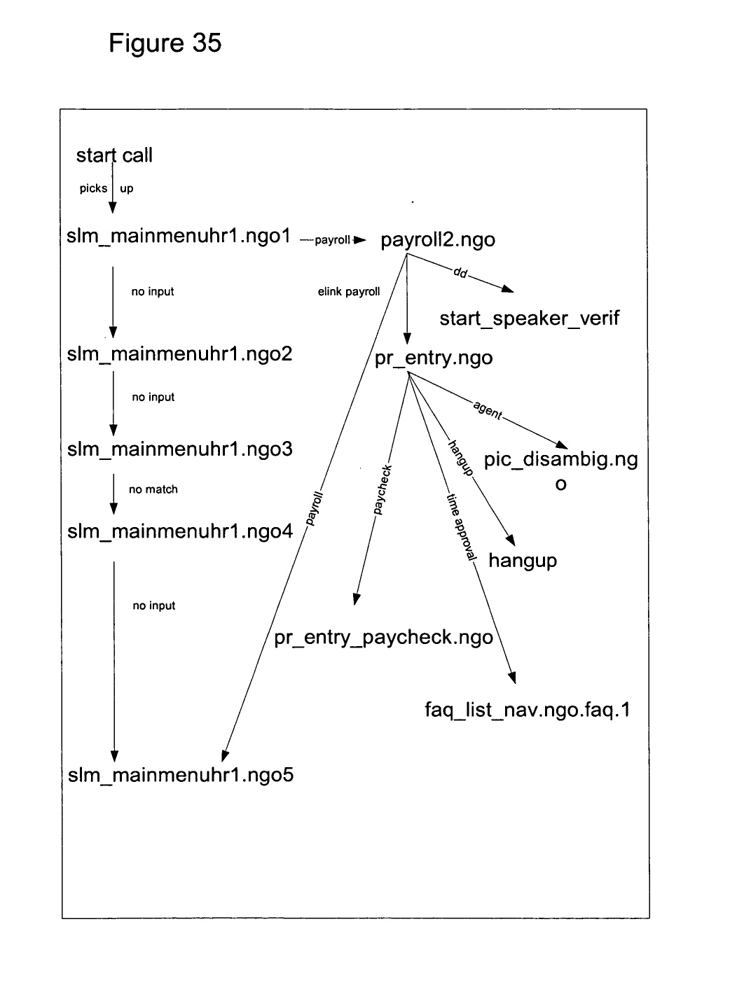

The number of consecutive interactions that users experience before moving out of the “main menu” dialog state is clearly pictured. The sub dialog state abstraction gauges the effectiveness of a system prompt/active grammar, as the screen shot shown in FIG. 35 illustrates. The effectiveness of the slm_mainmenu.ngo dialog state concept and how users request for a particular payroll topic is clearly shown.

As explained herein, users can be provided with an automated interactive statistical call visualization tool that uses an abstractions stack model framework. The tool is interactive, so that users viewing the call visualization can click and choose paths, expand details, break down abstractions, and collapse irrelevant information.

Further, when the user has found a flow pattern or statistic of interest, the user can take a snapshot (e.g., as a jpeg or other image format), which can be readily shared. Using an analogy of a typical business warehouse, a snapshot image is like a report, while the interactive information discovery process is like building a query, except the interactive process simultaneously displays the query result piece by piece, click by click.

Accordingly, using the present disclosure, a user may explore and understand usage patterns. The user can traverse paths of interest without needing to search for a particular diagram criterion that is identified in advance.

Although the present specification describes components and functions that may be implemented in particular embodiments with reference to particular standards and protocols, the invention is not limited to such standards and protocols. Each of the standards, protocols and languages represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

What is claimed is:

1. A method for visually presenting statistical speech recognition application call data, the method comprising:
building a data model using speech application data from disparate events;
modifying the data model using predetermined abstraction rules;
translating the modified data model into a visual representation of the modified data model with multiple levels of abstraction;
graphically displaying the visual representation of the data model via an interactive graphical user interface that accepts user requests; and
transforming a graphical display of the visual representation of the data model, in response to receiving a user request via the interactive graphical user interface, to change the graphical display of at least one first speech data aggregate at a first level of abstraction and the graphical display of at least one second speech data aggregate at a second level of abstraction.

2. The method for visually presenting statistical speech recognition application call data of claim 1,
wherein said transforming further comprises at least one of expanding, eliminating and grouping speech data aggregates, and
wherein said speech application data comprises statistics corresponding to at least one event recognized by a speech recognition application.

3. The method for visually presenting statistical speech recognition application call data of claim 1,
wherein call data is assigned different names at different abstraction levels, each name being determined based upon at least one characteristic of an associated speech data aggregate and a relationship with at least one other speech data aggregate, and
wherein disparate call data having a name in common is grouped to create a data structure that can be managed according to name components.

4. The method for visually presenting statistical speech recognition application call data of claim 1,
wherein the predetermined abstraction rules comprise a plurality of rules for naming speech data aggregates at a plurality of levels of abstraction, each of the plurality of rules being associated with a level of abstraction defined by the user, and each rule being used to examine call data characteristics, an examination result at least one of contributing to the determination of an intermediate name and being used to determine a final name for each speech data aggregate.

5. The method for visually presenting statistical speech recognition application call data of claim 1,
wherein a stack of predetermined abstraction rules defines a set of allowable transformations for at least one speech data aggregate, the stack of predetermined abstraction rules being customizable by the user so that speech data aggregates can be associated with different rules for display at different abstraction levels according to input of the user.

6. The method for visually presenting statistical speech recognition application call data of claim 1,
wherein new stacks are dynamically created from existing stacks, by at least one of inserting, deleting and changing an order of abstraction namers, and
wherein affected speech data aggregates are associated with a new stack when the user modifies the set of allowable transformations at run-time.

7. The method for visually presenting statistical call data of claim 1,
wherein the transformations comprise initially reducing the data structure to a set of speech data aggregates at an elemental level of abstraction, and combining data of speech data aggregates at the elemental level of abstraction to build at least one speech data aggregate at a higher level of abstraction, so that the visual representation of the data model comprises only an elemental level of abstraction and a topmost level of abstraction.

8. A computer readable medium for storing a computer program that visually presents statistical speech recognition application call data, comprising:
a model building code segment that builds a data model using speech application data from disparate events;
a model modifying code segment that modifies the data model using predetermined abstraction rules;
a model translating code segment that translates the modified data model into a visual representation of the data model with multiple levels of abstraction;
a model presenting code segment that graphically displays the visual representation of the data model via an interactive graphical user interface that accepts user requests; and
a display transforming code segment that transforms a graphical display of the visual representation of the data model, in response to receiving a user request via the interactive graphical user interface, to change the graphical display of at least one first speech data aggregate at a first level of abstraction and the graphical display of at least one second speech data aggregate at a second level of abstraction.

9. The computer readable medium of claim 8,
wherein said display transforming code segment at least one of expands, eliminates and groups speech data aggregates, and
wherein said speech application data comprises statistics corresponding to at least one event recognized by a speech recognition application.

10. The computer readable medium of claim 8, further comprising:
a naming code segment that assigns call data different names at different abstraction levels, each name being determined based upon at least one characteristic of an associated speech data aggregate and a relationship to at least one other speech data aggregate, and
wherein disparate call data having a name in common is grouped to create a data structure that can be managed according to name components.

11. The computer readable medium of claim 8,
wherein the predetermined abstraction rules comprise a plurality of rules for naming speech data aggregates at a plurality of levels of abstraction, each of the plurality of rules being associated with a level of abstraction defined by the user, and each rule being used to examine call data characteristics, an examination result at least one of contributing to the determination of an intermediate name and being used to determine a final name for each speech data aggregate.

12. The computer readable medium of claim 8, further comprising:
a stack of predetermined abstraction rules defining a set of allowable transformations for at least one speech data aggregate, the stack of predetermined abstraction rules being customizable by the user so that speech data aggregates can be associated with different rules for display at different abstraction levels according to input of the user.

13. The computer readable medium of claim 8, further comprising:
a new stack code segment that dynamically creates new stacks from existing stacks, by at least one of inserting, deleting and changing an order of abstraction namers,
wherein affected speech data aggregates are associated with a new stack when the user modifies the set of allowable transformations at run-time.

14. The computer readable medium of claim 8,
wherein the transformations comprise initially reducing the data structure to a set of speech data aggregates at an elemental level of abstraction, and combining data of speech data aggregates at the elemental level of abstraction to build at least one speech data aggregate at a higher level of abstraction, so that the visual representation of the data model comprises only an elemental level of abstraction and a topmost level of abstraction.

15. A visual statistical speech recognition application call data presenter, comprising:
a builder that builds a data model using speech application data from disparate events;
a modifier that modifies the data model using predetermined abstraction rules;
a translator that translates the modified data model into a visual representation of the modified data model with multiple levels of abstraction;
a model displayer that graphically displays the visual representation of the data model via an interactive graphical user interface that accepts user requests, and
a transformer that transforms a graphical display of the visual representation of the data model, in response to receiving a user request via the interactive graphical user interface, to change the graphical display of at least one first speech data aggregate at a first level of abstraction and the graphical display of at least one second speech data aggregate at a second level of abstraction.

16. The visual statistical speech recognition application call data presenter of claim 15,
wherein said model transformer at least one of expands, eliminates and groups speech data aggregates, and
wherein said speech application data comprises statistics corresponding to at least one event recognized by a speech recognition application.

17. The visual statistical speech recognition application call data presenter of claim 15, further comprising:
a namer that assigns call data different names at different abstraction levels, each name being determined based upon at least one characteristic of an associated speech data aggregate and a relationship to at least one other speech data aggregate,
wherein disparate call data having a name in common is grouped to create a data structure that can be managed according to name components.

18. The visual statistical speech recognition application call data presenter of claim 15, wherein the predetermined abstraction rules comprise a plurality of rules for naming speech data aggregates at a plurality of levels of abstraction, each of the plurality of rules being associated with a level of abstraction defined by the user, and each rule being used to examine call data characteristics, an examination result at least one of contributing to the determination of an intermediate name and being used to determine a final name for each speech data aggregate.

19. The visual statistical speech recognition application call data presenter of claim 15, wherein a stack of predetermined abstraction rules defines a set of allowable transformations for at least one speech data aggregate, the stack of predetermined abstraction rules being customizable by the user so that speech data aggregates can be associated with different rules for display at different abstraction levels according to input of the user.

20. The visual statistical speech recognition application call data presenter of claim 15,
wherein new stacks are dynamically created from existing stacks, by at least one of inserting, deleting and changing an order of abstraction namers, and
wherein affected speech data aggregates are associated with a new stack when the user modifies the set of allowable transformations at run-time.

21. The visual statistical speech recognition application call data presenter of claim 15, wherein the transformations comprise initially reducing the data structure to a set of speech data aggregates at an elemental level of abstraction, and combining data of speech data aggregates at the elemental level of abstraction to build at least one speech data aggregate at a higher level of abstraction, so that the visual representation of the data model comprises only an elemental level of abstraction and a topmost level of abstraction.
